(19) United States
(12) Patent Application Publication
(10) Pub. No.: US 2005/0204780 A1
(43) Pub. Date: Sep. 22, 2005

(54) Method for manufacturing optical fiber

(75) Inventors: Hideya Moridaira, Chiyoda-ku (JP); Masamitsu Uehara, Chiyoda-ku (JP); Tamotsu Kamiya, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd.

(21) Appl. No.: 10/513,670

(22) PCT Filed: May 8, 2003
(86) PCT No.: PCT/JP03/05760

§ 371 Date: Nov. 8, 2004

(30) Foreign Application Priority Data
May 9, 2002 (JP) 2002-134697
Jul. 8, 2002 (JP) 2002-199163
Jul. 8, 2002 (JP) 2002-199164

(51) Int. Cl. C03B 37/027

(52) U.S. Cl. 65/407; 65/412

(57) ABSTRACT

A method of manufacturing an optical fiber, characterized by comprising the steps of forming a glass body having a core, forming a glass tube constituting a clad portion, inserting the glass body into the glass tube, forming the glass body integrally with the glass tube, finishing at least the extraction side end part of the glass tube in a tapered shape and washing the outer surface of the glass tube, characterized in that a difference between the outer diameter of the glass body and the inner diameter of the glass tube is 1.0 to 10.0 mm, and the inner diameter of a support tube fitted to one end of the glass tube is increased more than that of the glass tube or the extraction side end part of the glass tube is sealed with a tapered part provided at least on the inner surface thereof and a spacer is installed so that a clearance between the outer diameter of the glass body and the inner diameter of the glass tube becomes generally constant in the longitudinal direction.

### TECHNICAL FIELD

The present invention relates to the method for manufacturing an optical fiber, more specifically to the method for manufacturing an optical fiber for telecommunication.

### RELATED ART

Silica glass is used as the base material of an optical fiber. Generally, method for manufacturing an optical fiber proceeds as follows: a preform having a predetermined refractive index profile is synthesized; it is melted and softened in a heating furnace; and it is pulled to be a thin fiber. The proposed preform synthesizing methods include MCVD method, VAD method, OVD method and so on.

For example, according to a known method for preparing a preform shown in FIG. 6A, a glass body including a core which will form a central portion of an optical fiber (which may be called a core-rod hereinafter) is manufactured by one of the above methods (VAD method in the particular embodiment shown in FIG. 6) to produce a core-rod 61, and a jacketing tube 62 made of silica glass is prepared to form a cladding portion. The core-rod 61 and jacketing tube 62 are held by a core-rod supporting rod 64 and jacketing tube supporting tube 63, respectively, and they are collapsed by heating as shown in FIG. 6B to produce a preform. It is also known that collapsing the two glass elements is achieved simultaneously with their drawing.

Usually, an electrical furnace is used for a heating furnace attached to an optical fiber-drawing equipment, and it is heated to 2000° C. or higher. A preform is inserted into the furnace, and one end is melted by heating and pulled to produce a fiber. When the drawing condition proceeds to a stable condition, the tip shape of the preform exhibits a stable profile determined by the outer diameter of the preform and its viscosity, distribution of temperatures within the heater of the furnace, and drawing speed. The characteristic of the obtained fiber is also stable. If the drawing is performed simultaneously with collapsing the two glass elements, air existing at a gap between a jacketing tube and a core-rod inserted therein is aspirated, for example, by means of a vacuum pump so that the pressure within the gap is reduced. Then, at the neck-down portion, the core-rod and the jacketing tube are collapsed by heating, and a thin fiber can be obtained by drawing the collapsed glass elements. Incidentally, in order to insert a core-rod into the central cavity of a jacketing tube which will form a cladding portion, for example, a method as shown in FIG. 28 has been employed. Namely, a core-rod 353 and a jacketing tube 351, both of which have been processed so as to have a predetermined size, are mounted on a vertically movable lathe, and the core-rod 353 is allowed to slowly descend in a direction indicated by the arrow shown in FIG. 28 until it is inserted into and housed in the central cavity of the jacketing tube 351.

However, immediately after the onset of drawing, the tip shape of the preform is different from the stable one described above, and the drawing condition is unstable. To improve this inconvenience, a method has been proposed which includes to make a pre-processing the tip shape of a preform (Japanese Unexamined Patent Application Publications Nos. 7-330362 and 8-310825). According to this method, it becomes possible to reduce the occurrence of failures which were previously encountered often immediately after the onset of drawing, such as the deviation of fiber diameter or fiber characteristics from designed ranges, and to improve the production efficiency.

True, to process a tip of a preform in a conical shape is effective for producing fibers as described above. However, according to this method, it is necessary to process the tip of a preform, subsequent to the synthesis of the preform. This means, according to this method, it is necessary to introduce an additional step for obtaining a finished preform, which is not required in a conventional method. Moreover, introduction of an additional step may increase the risk of the preform being damaged by accident.

Furthermore, introduction of an additional step may increase the risk of a preform being contaminated, which may lead to the reduced strength of the fiber obtained therefrom.

As preforms become large, machines responsible for their processing must be large, and then workability is impaired, and cost required for the installment and running of the machines increases.

Incidentally, in the working environment where manufacture of optical fibers is carried out, foreign matters such as particles of dusts and oil may be present. If such a foreign matter adheres to the surface of a jacketing tube, and left uncleaned, the matter will remain on the surface of the resulting optical fiber. This may result in the reduced strength of the optical fiber because, if the fiber is exposed to an external force, stresses will concentrate on this soiled spot. To prevent this, the matters on the jacketing tubes and others must be removed by cleaning before the Jacketing tubes and others are drawn into thin fibers.

Several methods have been proposed for cleaning jacketing tubes. Usually, a wet method is employed in which jacketing tubes are rinsed with a detergent. The detergent may include an aqueous solution of hydrofluoric acid that has an etching ability, or a surfactant solution. If the surface of jacketing tubes is purified as a result of cleaning, the resulting optical fibers will have a reliably improved strength.

Incidentally, if the cleaning method consists of filling a tank with a detergent solution, placing jacketing tubes in the tank awhile, and removing the jacketing tubes from the tank to transfer them into another tank filled with purified water for rinsing, the detergent solution may soak into the central cavity of the jacketing tubes. Since the central cavity of a jacketing tube is comparatively inaccessible to water even when the jacketing tube is rinsed with water, the detergent solution soaking in the central cavity of the tube may remain uncleaned even after rinsing. If a droplet of an aqueous solution of hydrofluoric acid remains uncleaned in the central cavity of a jacketing tube, it may leave a pit there.

If a jacketing tube whose central cavity is contaminated or roughened is used for the method for manufacturing an optical fiber, the outer diameter of the resulting optical fiber will fluctuate during drawing, and thus acquisition of a high quality optical fiber will become impossible. In worst cases, the optical fiber may be broken as a result of the diameter fluctuation during drawing. Such contamination or roughness of the cavity of jacketing tubes will also suffer from reduced strength. Prevention of these flaws will be possible by introducing an additional step that consists of cleaning and polishing the central cavity of jacketing tube after the overall cleaning of the jacketing tube. However, introduction of such an additional step will lead to the reduced productivity. Once core-rod is inserted into the jacketing tube, it will be difficult to introduce an additional step for cleaning and polishing the central cavities of the jacketing tube.

Reviewing the problems encountered with conventional methods as described above, an object of the present invention is to provide a method for manufacturing an optical fiber, the manufacture comprising mounting a preform on a fiber-drawing equipment, and pulling one end of the preform while its tip being heated until it becomes a thinned fiber, whereby it is possible to reduce the duration of initial unstable drawing-phase lasting from the onset of fiber-drawing up to the establishment of stable fiber-drawing, that is, to minimize the wasteful fibers manufactured during the initial unstable drawing-phase in the production of an optical fiber, and to minimize the time loss spent for the wasteful production. Another object of the present invention is to provide a method for treating a preform of an optical fiber such that an optical fiber obtained as a result of fiber-drawing can have a sufficient strength.

### SUMMARY OF THE INVENTION

A first embodiment of the method of the present invention for manufacturing an optical fiber comprises the steps of forming a glass body containing a core, preparing a glass tube which will form a cladding portion, processing one end of the glass tube to be drawn so as to be tapered to make an over-jacketing glass tube, inserting the glass body into the over-jacketing glass tube, and collapsing the over-jacketing glass tube with the glass body by heating.

A second embodiment of the method of the present invention for manufacturing an optical fiber is characterized by that the tapered end of the over-jacketing glass tube similar in form to a meniscus during drawing from the glass assembly to make the optical fiber.

A third embodiment of the method of the present invention for manufacturing an optical fiber is characterized by that the step of collapsing the over-jacketing glass tube with the glass body by heating comprises steps of sealing one end of the glass assembly by heating, and collapsing the over-jacketing glass tube with the glass body by heating at the same time of drawing to the optical fiber while reducing a pressure within the gap between the glass body and the glass tube.

A fourth embodiment of the method of the present invention for manufacturing an optical fiber is characterized by that the step of processing one end of the glass tube to be tapered to make the over-jacketing glass tube comprises abrasion-machining one end of the glass tube, and cleaning of the abraded portion.

A fifth embodiment of the method of the present invention for manufacturing an optical fiber is characterized by that the step of polishing of the abraded portion.

A sixth embodiment of the method of the present invention for manufacturing an optical fiber is characterized by that the method further comprises a step of processing one end of the glass body so as to be tapered to make a processed glass body, and the tapered portions of both the over-jacketing glass tube and the processed glass body are formed in nearly the same longitudinal position at the commencement of collapsing the over-jacketing glass tube with the glass body by heating.

A seventh embodiment of the method of the present invention for manufacturing an optical fiber is characterized by further comprising a step of processing one end of the glass tube to be drawn so as to be tapered to make the over-jacketing glass tube comprises of heating and elongating one end of the glass tube to be drawn so as to be tapered to make the over-jacketing glass tube, and sealing the tapered end of the over-jacketing glass tube.

An eighth embodiment of the method of the present invention for manufacturing an optical fiber is characterized by that the method further comprises a step of processing one end of the glass body so as to be tapered to make the processed glass body, inserting the processed glass body into the over-jacketing glass tube, and making the ends of both the processed glass body and the over-jacketing glass tube together in nearly the same longitudinal position.

A ninth embodiment of the method of the present invention for manufacturing an optical fiber comprises the steps of forming a glass body containing a core, preparing a glass tube which will form a cladding portion, cleaning the outer surface of the glass tube, inserting the glass body into the glass tube, and collapsing the glass tube with the glass body by heating.

A tenth embodiment of the method of the present invention for manufacturing an optical fiber is characterized by that the method further comprises steps of sealing the end of the glass tube to be drawn, and attaching a supporting tube to the opposite end of the glass tube to be sealed, and that the step of cleaning the outer surface of the glass tube is made after attaching a plug into the supporting tube.

An eleventh embodiment of the method of the present invention for manufacturing an optical fiber is characterized by that the method further comprises steps of sealing one end of the glass tube to be drawn and attaching a supporting tube to the opposite end of the glass tube to be drawn, and that the step of cleaning the outer surface of the glass tube is made after inserting the glass body into the glass tube and attaching a plug to the supporting tube.

A twelfth embodiment of the method of the present invention for manufacturing an optical fiber comprises the steps of forming a glass body containing a core, preparing a glass tube which will form a cladding portion, first cleaning the outer surface of the glass tube (, wrapping the outer surface of the glass tube with a film, inserting the glass body wrapped with the film into the glass tube, removing the film from the glass body after inserted into the glass tube, attaching a plug to an open end of the glass tube with the glass body, second cleaning the outer surface of the glass tube with the glass tube, and collapsing the glass tube with the glass body by heating.

A thirteenth embodiment of the method of the present invention for manufacturing an optical fiber is characterized by that all the steps of cleaning the outer surface of the glass tube are comprising of treating the outer surface of the glass tube by using an aqueous solution of hydrofluoric acid by 1 to 20 wt %, rinsing it with pure water, and drying it.

A fourteenth embodiment of the method of the present invention for manufacturing an optical fiber is characterized by that the cleaning step comprises rinsing the outer surface of the glass tube with pure water having electric conductivity of 1 μA or less.

A fifteenth embodiment of the method of the present invention for manufacturing an optical fiber comprises the steps of forming a glass body containing a core, preparing a glass tube which will form a cladding portion, inserting the glass body into the glass tube and collapsing the glass tube with the glass body by heating, wherein the difference (dp−D1) between the outer diameter (D1) of the glass body and the inner diameter (dp) of the glass tube is not less than 1.0 mm and not more than 10.0 mm.

A sixteenth embodiment of the method of the present invention for manufacturing an optical fiber characterized by that the method further comprises a step of attaching a supporting tube to an inert end of the glass tube, wherein the difference (ds−D1) between the outer diameter (D1) of the glass body and the inner diameter (ds) of the supporting tube is not less than 1.0 mm and not more than 10.0 mm, and the difference (db−D1) between the outer diameter (D1) of the glass body and the inner diameter (db) of the attached supporting tube to one end of the glass tube is not less than 1.0 mm and not more than 10.0 mm.

A seventeenth embodiment of the method of the present invention for manufacturing an optical fiber is characterized by that the method further comprises a step of attaching a supporting tube to one inert end of the glass tube, wherein the supporting tube is made of natural silica glass.

An eighteenth embodiment of the method of the present invention for manufacturing an optical fiber comprises the steps of forming a glass body containing a core, preparing a glass tube which will form a cladding portion, attaching a supporting tube to one end of the glass tube, inserting the glass body into the glass tube attached with the supporting tube and collapsing the glass tube with the glass body by heating, wherein the inner diameter (ds) of the supporting tube is not less than the inner diameter (dp) of the glass tube; ds≧dp.

A nineteenth embodiment of the method of the present invention for manufacturing an optical fiber is characterized by that the outer diameter (Ds) of the supporting tube is not less than the outer diameter (Dp) of the glass tube; Ds≧Dp.

A twentieth embodiment of the method of the present invention for manufacturing an optical fiber is characterized by that the step of attaching a supporting tube to one inert end of a glass tube is made by welding, and further comprises a step of making an outer diameter of the welded portion not more than that of the supporting tube.

A twenty-first embodiment of the method of the present invention for manufacturing an optical fiber is characterized by that the supporting tube is made of natural silica glass.

A twenty-second embodiment of the method of the present invention for manufacturing an optical fiber comprises the steps of forming a glass body containing a core, preparing a glass tube which will form a cladding portion, sealing one end of the glass tube to be drawn by processing at least internal surface of the end of the glass tube so as to be tapered to make an over-jacketing tube, inserting the glass body into the over-jacketing glass tube, providing a spacer so as to keep a gap in substantially constant longitudinally between the outer surface of the glass body and the inner surface of the over-jacketing glass tube except the tapered portion, and collapsing the over-jacketing glass tube with the glass body by heating.

A twenty-third embodiment of the method of the present invention for manufacturing an optical fiber is characterized by that the method further comprises steps of attaching a supporting tube to an opposite end of the glass tube to be drawn, and attaching a supporting rod to an opposite end of the glass body to be drawn, wherein the spacer is provided into the gap between the outer surface of the supporting rod and the inner surface of the supporting tube.

A twenty-fourth embodiment of the method of the present invention for manufacturing an optical fiber is characterized by that, wherein one end of the glass rod is butted and aligned with one end of the glass tube to be tapered, so as to be arranged concentrically.

A twenty-fifth embodiment of the method of the present invention for manufacturing an optical fiber is characterized by that the spacer is provided after the step of inserting the glass body into the over-jacketing glass tube.

A twenty-sixth embodiment of the method of the present invention for manufacturing an optical fiber is characterized by that the method further comprises steps of attaching a supporting rod concentrically to an opposite end of the glass body to be drawn, and attaching a supporting tube concentrically to an opposite end of the over-jacketing glass tube to be drawn.

A twenty-seventh embodiment of the method of the present invention for manufacturing an optical fiber is characterized by that the supporting rod comprises a stopper portion for keeping the spacer in position.

A twenty-eighth embodiment of the method of the present invention for manufacturing an optical fiber is characterized by that the spacer is made of silica glass.

A twenty-ninth embodiment of the method of the present invention for manufacturing an optical fiber is characterized by that the spacer has a circular cross-section with a first hole at the center and a second hole, wherein outer diameter of the spacer is selected to fit to the inner diameter of the over-jacketing glass tube, outer diameter of the first hole is selected for the glass rod to pass through therein, and outer diameter of the second hole is selected to be sufficient to reduce a pressure within a gap between the over-jacketing glass tube and the glass rod during fiber-drawing.

A thirtieth embodiment of the method of the present invention for manufacturing an optical fiber is characterized by that the spacer has a circular cross-section with a first hole at the center and a plural of second slitted holes radially arranged, wherein outer diameter of the spacer is selected to fit to the inner diameter of the over-jacketing glass tube, outer diameter of the first hole is selected for the glass rod to pass through therein, and outer diameter of a plural of second holes radially arranged are selected to be sufficient to reduce a pressure within a gap between the over-jacketing glass tube and the glass rod during fiber-drawing.

A thirty-first embodiment of the method of the present invention for manufacturing an optical fiber is characterized by that wherein the spacer has a circular cross-section with a first hole at the center and a lot of second small holes, wherein outer diameter of the spacer is selected to fit to the inner diameter of the over-jacketing glass tube, outer diameter of the first hole is selected for the glass rod to pass through therein, and outer diameter of a lot of second small holes are selected to be sufficient to reduce a pressure within a gap between the over-jacketing glass tube and the glass rod during.

A thirty-second embodiment of the method of the present invention for manufacturing an optical fiber is characterized by that the method further comprises a step of processing one end of the glass body to be drawn so as to be, wherein the tapered angle of the glass body is sharper than that of the over-jacketing glass tube.

A thirty-third embodiment of the method of the present invention for manufacturing an optical fiber comprises the steps of forming a glass body containing a core, preparing a glass tube which will form a cladding portion, processing at least a one end of the glass tube to be drawn to make an over-jacketing glass tube, inserting the glass body into the over-jacketing glass tube, and collapsing the over-jacketing glass tube with the glass body by heating, wherein the resulting optical fiber has a transmission loss of 0.4 dB/km or less at a wavelength of 1385 nm.

A thirty-fourth embodiment of the method of the present invention for manufacturing an optical fiber is characterized by that the glass tube is made of synthetic silica glass of 100 ppm or less in OH-group concentration.

### BRIEF DESCRIPTION OF THE DRAWINGS

FIG. 1 illustrates, in a cross-sectional view, the shape of a tip of a preform undergoing fiber-drawing which represents an embodiment of the present invention.

FIG. 2 illustrates how a core soot is formed by VAD method.

FIG. 3 illustrates, in a cross-sectional view, the step of abrading the outer surface of a tip according to an embodiment of the present invention.

FIG. 4 illustrates, in a cross-sectional view, the step of collapsing a jacketing tube to a glass body by heating while the glass assembly is drawn.

FIG. 5 illustrates, in a cross-sectional view, how a cone-shaped abrasion stopper rod is inserted into a jacketing tube according to an embodiment of the invention.

FIG. 6 illustrates, in a cross-sectional view, (A) how a core rod is placed with respect to a jacketing tube before collapsing, and (B) how the core rod is collapsed with the jacketing tube after collapsing, according to a conventional method.

FIG. 7 illustrates, in a cross-sectional view, how glass elements change their profile before and after they are collapsed according to a method of the first embodiment: FIG. 7A illustrates, in profile, a core-rod and a jacketing tube before they are collapsed, and FIG. 7B illustrates, in profile, how the core-rod and jacketing tube are collapsed.

FIG. 8 illustrates, in cross-sectional views, how glass elements change their profile before and after they are collapsed according to a method of the second embodiment: FIG. 8A illustrates, in profile, a core-rod and a glass tube before they are collapsed, and FIG. 8B illustrates, in profile, how the core-rod and jacketing tube are collapsed to form a preform.

FIG. 9 illustrates, in cross-sectional views, how glass elements change their profile before and after they are collapsed according to a method of the third embodiment: FIG. 9A illustrates, in profile, a core-rod and a jacketing tube before they are collapsed, and FIG. 9B illustrates, in profile, how the core-rod and jacketing tube are collapsed to form a preform.

FIG. 10 illustrates, in cross-sectional views, how glass elements change their profile before and after they are collapsed according to a method of the fourth embodiment: FIG. 10A illustrates, in profile, a core-rod and a jacketing tube before they are collapsed, FIG. 10B illustrates the profile of the jacketing tube before collapsing, and FIG. 10C illustrates how fiber-drawing is performed.

FIG. 11 illustrates the outline of VAD method.

FIG. 12 shows, in a cross-sectional view of a preform representing an embodiment of the present invention, the relative sizes of its various components.

FIG. 13 outlines a jacketing tube attached to a supporting tube sealed with a plug.

FIG. 14 shows the steps for cleaning a jacketing tube.

FIG. 15 illustrates how a core-rod is inserted into a jacketing tube.

FIG. 16 illustrates how a cap is applied to a supporting tube attached to a jacketing tube.

FIG. 17 is a schematic view for showing how a core-rod is inserted into and housed in a jacketing tube.

FIG. 18 shows relationship of the core eccentricity with the difference between the outer diameter of core-rods and the inner diameter of jacketing tubes.

FIG. 19 is a diagram for showing how a core-rod is inserted into a jacketing tube.

FIG. 20 is a schematic view for showing how a core-rod is inserted into and housed in a jacketing tube.

FIG. 21 is a diagram for showing how a core-rod is inserted into and housed in a jacketing tube according to a method representing an embodiment of the present invention.

FIG. 22 is a diagram for showing how a core-rod is inserted into and housed in a jacketing tube according to a method representing another embodiment of the present invention.

FIG. 23 is a diagram for showing how a core-rod is inserted into and housed in a jacketing tube according to a method known in the prior art.

FIG. 24 is a diagram for showing how a core-rod is inserted into a jacketing tube.

FIG. 25 is a diagram for showing how a core-rod is inserted into and housed in a jacketing tube according to a method representing an embodiment of the present invention.

FIG. 26 is a diagram for showing how a core-rod is inserted into a jacketing tube made of synthetic silica glass which is followed by the insertion of a spacer according to a method representing an embodiment of the present invention.

FIG. 27 shows schematic sectional views of two exemplary spacers.

FIG. 28 is a diagram for showing how a core-rod is inserted into a jacketing tube according to a method known in the prior art.

FIG. 29 illustrates how a core-rod and a jacketing tube are arranged with respect to each other before they are collapsed according to another embodiment of the present invention.

### DETAILED DESCRIPTION OF THE INVENTION

The method of the present invention does not aim to shape the drawn end of a synthesized preform before the onset of fiber-drawing, but to prepare a preform during its synthesis such that its one end which will be drawn has a desired shape, thereby eliminating the works accompanying with the tip shaping, and reducing the extra risk of disorders and increased cost.

The present invention will be described below with reference to the attached drawings as needed. However, those drawings represent only the preferred illustrative embodiments of the present invention, and the present invention is not limited to those embodiments.

Usually, a fiber-drawing equipment comprises a furnace, resin coater, resin curing unit, and take-up capstan arranged vertically. Glass preform is melted in the furnace, and a resulting optical fiber is taken up continuously by the capstan. For fiber-drawing, it is necessary to pull out a starting end from the glass preform. For this purpose, a preform is placed in the furnace which is then heated to melt the tip of the preform, and the tip is allowed to fall because of its own weight, then the tip is received.

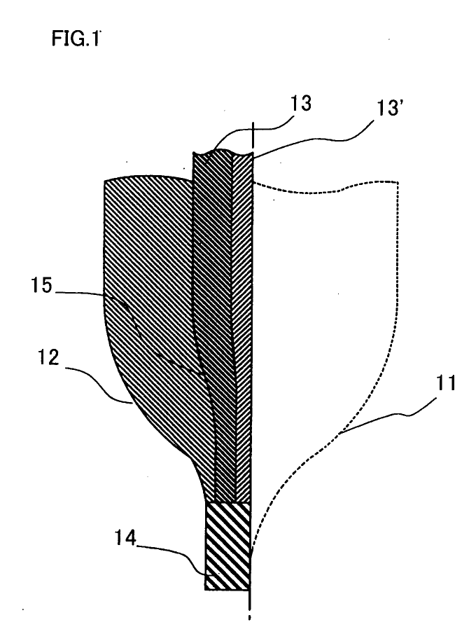

Therefore, a starting end of a preform desirably has a conical shape with a weight 14 on its tip as shown in FIG. 1.

Furthermore, the shape 12 (conical shape) of the tip of a preform is preferably similar to the meniscus profile 11 (drawn in the same figure as a reference) of the preform formed when it is drawn into a fiber. Abrasion-machining for tapering a tip of a preform according to the present invention is carried out such that the resulting taper has a profile similar to the profile 11.

The method of the present invention for preparing a preform is characterized by comprising two stages. According to this method, it is possible to produce a glass body containing a core portion and another glass body which is exclusively used for the formation of a cladding portion independently of each other. Since a glass body containing a core portion is allowed to have an appropriate refractive index profile during its synthesis, it will make a high quality optical fiber even when machining is applied to its terminal end before it is collapsed with a glass body which is exclusively used for the formation of a cladding portion, and the impairment of productivity as a result of machining can be safely avoided.

The glass body exclusively used for the formation of a cladding portion may be made of, for example, synthetic silica glass. Collapsing of a layer comprising a glass body exclusively used for the formation of a cladding portion with a glass body containing a core portion can be achieved by a jacketing method (method 1 below) in which a glass body containing a core portion is inserted into a jacketing tube (e.g., silica glass tube), and the glass assembly is heated to be collapsed, or by a simultaneous collapsing method during drawing (method 2 below) in which the glass assembly is drawn into a thin fiber while it is heated to be collapsed. By either method, it is possible to form a layer comprising a glass body exclusively used for the formation of a cladding portion around the outer surface of a rod-like glass body.

1) Jacketing Method

Usually, a glass tube (which is called a jacketing tube hereinafter) used for the formation of a cladding portion which may be made of, for example, silica glass can be obtained by shaping a hollow ingot into a tube, further thinning the tube by elongation, and cutting with a cutter into pieces of tubes having a desired length. Thus, the hollow ingot tube and tube piece have a cylindrical shape whose both ends are flatly cut. A core-rod is inserted into such a tube, and then the glass elements are heated from outside so that the glass elements are melted to be collapsed.

As a consequence, the both ends of the effective portion have a smooth cylindrical. When the end is pulled while the tip is heated by means of the flame of a burner or heater of an electric furnace, the above-mentioned problem that the drawing condition is unstable in the initial drawing phase happens.

2) Simultaneous Collapsing Method During Drawing

Usually, a jacketing tube to which the simultaneous collapsing method during drawing is applied has a smooth cylindrical shape with flatly cut ends as described above, and thus faces the same problem. Moreover, with the simultaneous collapsing method during drawing, it is necessary to seal, in advance, the drawn end of a jacketing tube because the pressure within the gap between the core-rod and the jacketing tube must be reduced during fiber-drawing. If a core-rod is inserted into a jacketing tube, and then a drawn end of the jacketing tube is contracted by heating to be collapsed with the core-rod, it will be difficult to process the drawn end into taper shape efficiently thereafter.

The method of the present invention can be applied to the jacketing method and/or simultaneous collapsing method during drawing.

According to the method of the present invention, the outer surface of a drawn end of a glass tube is processed such that the end is tapered. Tapering is achieved by abrasion-machining. This ensures efficient tapering.

After abrasion-machining, particles of an abrasion agent or abraded glass may adhere to the surface of a jacketing tube, and if they are left uncleaned, the resulting fiber will suffer from diameter fluctuation or reduced strength. Therefore, it is desirable to clean the abraded portion of a jacketing tube. The processed portion may preferably have a smooth surface because the outer diameter of the fiber is stabilized comparatively quickly at the initial phase of fiber-drawing.

Alternatively, a drawn end of a jacketing tube is processed in advance to be tapered, a core-rod is inserted into the jacketing tube, and the drawn end of the glass assembly is pulled while its tip is heated so that the end is sealed and tapered at the same time. This method is also effective. A method in which a long jacketing tube is prepared and slowly elongated while its center portion is heated, is particularly preferred because of its high efficiency, because, with this method, two jacketing tubes which are applied the processing of the tapering in the drawn end of them are obtained at a single activation.

In any case, a drawn end of a core-rod is preferably processed to be tapered in advance, because then the outer diameter of the fiber is stabilized quickly as compared with a fiber for which a non-tapered core-rod is used. Ideally, the tapered end of a glass assembly is shaped such that, at any given cross-section, the ratio (core/clading ratio) of the core area to the cladding area becomes constant. To obtain a glass assembly exhibiting a cross-section as close to the required cross-section as possible, it is preferred to process a drawn end of a core-rod to take a conical shape. It will be advantageous if it is possible to obtain a glass assembly in which the core/cladding ratio at the base of the taper is close to the required one. This is because, when thinning of a glass assembly into a fiber is achieved by pulling its drawn end, the starting end of a usable fiber corresponds practically with the base of the taper of the glass assembly.

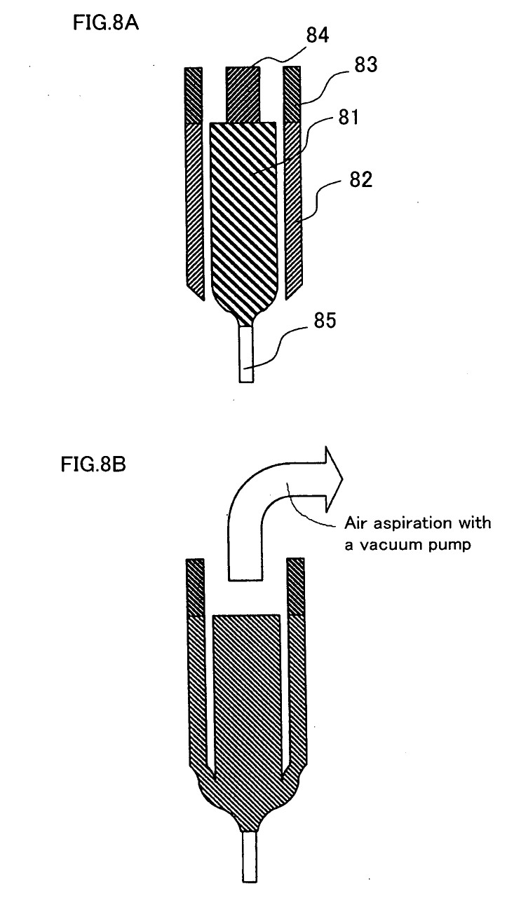

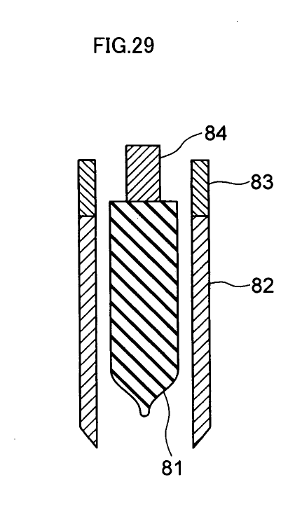

Incidentally, if the taper portion of a jacketing tube is displaced from the taper portion of a core-rod in a longitudinal direction as shown in FIG. 29, the clearance between the two portions is so large that welding of the two elements may not occur satisfactorily. To meet such situation, preferably, the taper portion of a core-rod is positioned practically at the same level in a longitudinal direction with the taper portion of the jacketing tube as shown in FIG. 8, just before the jacketing tube is collapsed with the core-rod. It is prevented that the clearance becomes too large by positioning the two elements as described above.

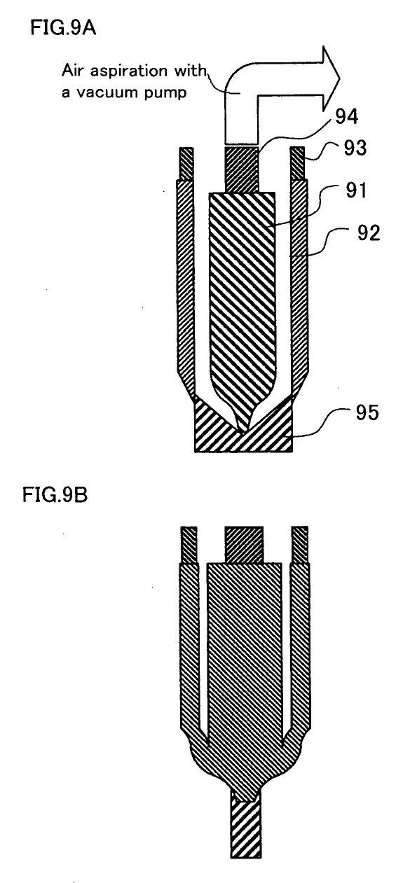

Moreover, it is possible to employ a supporting member such as a jacketing tube sealing rod 95 shown in FIG. 9A to ensure that the taper portion of a core-rod corresponds in position in a longitudinal direction with the taper portion of a jacketing tube.

The present invention further provides a method for cleaning a preform of an optical fiber. The cleaning method is applied to the outer surface of a jacketing tube, and occurs at one or more steps being introduced, in the method for manufacturing an optical fiber comprising the steps of forming a core-rod, inserting the core-rod into the central cavity of a jacketing tube prepared separately, and pulling a drawn end of the glass assembly while heating its tip to collapse the jacketing tube with the core-rod which results in the production of an optical fiber, between the jacketing tube preparing step and fiber-drawing step.

A preform is set in a fiber-drawing equipment, and its drawn end is pulled while its tip is heated to be drawn into a thin fiber according to the method, the resulting fiber has a satisfactory dimension and strength. Namely, cleaning of a preform ensures the improved strength of the resulting optical fiber obtained by drawing the preform.

Incidentally, if a core-rod is inserted into a cavity of a jacketing tube and the glass assembly is immersed in a cleaning solution, the cleaning solution will soak into the gap between the core-rod and the jacketing tube. If such a preform is subjected to fiber-drawing, the resulting fiber will suffer from diameter fluctuation. To prevent such inconveniency, it is necessary to attach a plug to an open end of the assembly for fear that cleaning solution should soak into the cavity of the jacketing tube. According to the present invention, it is possible to prevent the invasion of foreign matters into the cavity of a jacketing tube during handling.

A method of the present invention comprises the steps of sealing an end of a jacketing tube, welding a silica glass tube to the other end of the jacketing tube for facilitating handling, attaching a plug to the open end of the supporting silica glass tube, and cleaning the jacketing tube while preventing the soak of rinsing water into the cavity of the jacketing tube during cleaning.

For example, if only the outer surface of a jacketing tube whose ends are both opened must be cleaned, it is impossible to immerse the tube in cleaning solution. A remaining method is to pour cleaning solution on the outer surface of a jacketing tube. However, stray sprays of cleaning solution may enter within the cavity of the jacketing tube during cleaning. If a jacketing tube to be cleaned has one end sealed, it is possible to clean the jacketing tube while preventing the entry of cleaning solution into the cavity of the tube by holding the jacketing tube vertically with the sealed end directed to downward, descend the tube into a cleaning solution until the portion of the tube requiring cleaning is submerged in the solution. However, in this case, it is necessary to control the surface level of cleaning solution for fear that superfluous solution should go beyond the edge of the jacketing tube to enter into its central cavity. Cleaning by pouring cleaning solution described above will face the same problem as described above.

Incidentally, if open ends of the hollow tube are closed with plugs, such closed tube will be convenient because of its ease of cleaning as well as handling: such a closed tube is safely protected against the entry of foreign matters as well as of solution.

According to the invention, as shown in FIG. 13, a jacketing tube 231 has one end sealed. A supporting silica glass tube 233 is attached by welding to the open end of the jacketing tube 231. The supporting tube 233 is made of a silica glass tube which has an outer surface substantially uniformly flat in a longitudinal direction (diameter fluctuation being desirably ±1 mm/1 m) for fear that the supporting tube, when it is held by a chuck of a lathe, should undergo unnecessary deformation. The free end of the supporting tube is shaped in such a manner as to facilitate its attachment to a vacuum pump or to a fiber-drawing equipment. The supporting tube preferably has an outer diameter practically the same with that of the jacketing tube, and an inner diameter larger than that of a jacketing tube. To the free end of the supporting tube 233 is attached a plug 235, for example, plug made of silicon rubber.

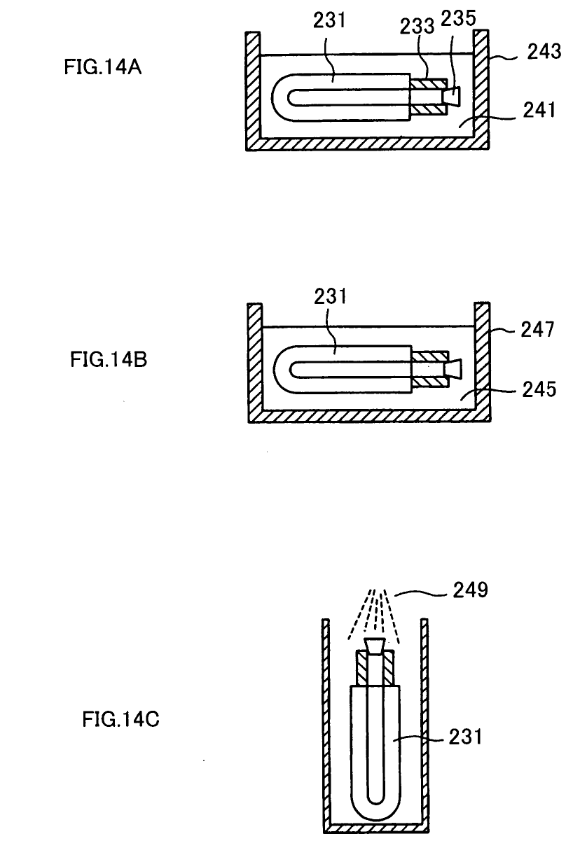

Next, as shown in FIG. 14A, the jacketing tube 231 jointed to the supporting tube 233 whose free end is closed with the plug 235 is transferred into a tank 243 filled with an aqueous solution of hydrofluoric acid 241. The jacketing tube is then transferred into another tank 247 filled with purified water 245 as shown in FIG. 14B to wash roughly. Then, as shown in FIG. 14C, a shower 249 of purified water is poured onto the jacketing tube for water rinsing, compressed air is applied to the jacketing tube to blow off water droplets from it, and the jacketing tube is left to dry.

According to the embodiment of the present invention, it is possible to improve the reliable strength of an optical fiber and reduce the occurrence of disorders during fiber-drawing by cleaning the outer surface of a jacketing tube jointed to a supporting tube 231 whose free end is closed with a plug 235.

According to the present invention, cleaning of a jacketing tube consists of employing a 1 to 20 wt % aqueous solution of hydrofluoric acid, treating the jacketing tube with the hydrofluoric acid solution, rinsing the tube with purified water, and drying the tube. If the degree of the contamination of a jacketing tube is little, rinsing with purified water will be sufficiently effective.

The purified water used in the cleaning step preferably includes purified water prepared by ion exchanging method whose electric conductivity is kept 1 μA or lower.

A method of the present invention comprises wrapping the outer surface of a jacketing tube with a protective film after cleaning, inserting a core-rod into the wrapped jacketing tube, removing the film after the insertion, attaching a plug to the free end of a supporting tube jointed to the jacketing tube for fear that cleaning solution should enter into the cavity of the jacketing tube during cleaning, and cleaning the jacketing tube again. Wrapping the surface of a jacketing tube with a film after cleaning will minimize the risk of renewed contamination of the surface of the jacketing tube, and prevents contamination during the insertion of a core-rod or during handling including transportation.

However, the protective film itself may be contaminated with foreign matters. To meet such situation, it is advisable to clean a jacketing tube just before fiber-drawing. This is particularly important for the fiber-drawing which requires the outer surface of a jacketing tube to have a high degree of purity.

Yet another method of the present invention comprises the steps of sealing one end of a jacketing tube, attaching a supporting silica glass tube by welding to the unsealed end of the jacketing tube, inserting a core-rod into the central cavity of the jacketing tube, attaching a plug to the free end of the supporting tube for fear that cleaning solution should enter into the cavity of the jacketing tube, and cleaning the glass assembly.

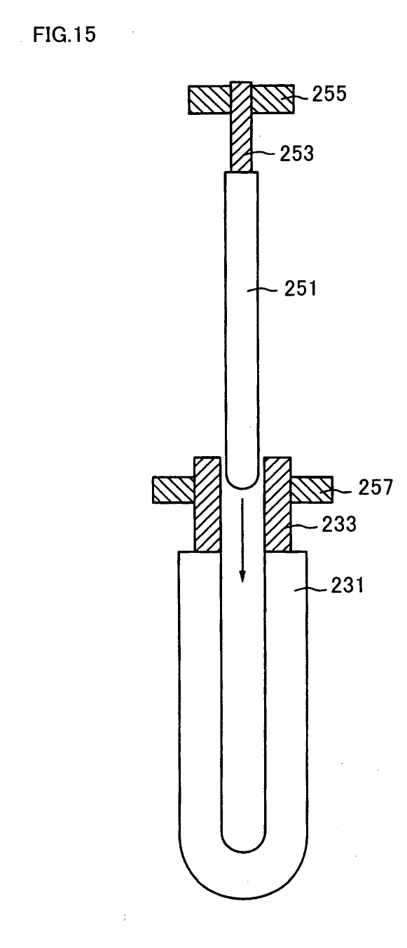

For example, as shown in FIG. 15, a supporting rod 253 is attached to a core-rod 251 which has been processed to have a specified dimension. The supporting rod 253 attached to the core-rod 251 is fixed via a chuck 255 to a vertically movable lathe. A supporting tube 233 jointed to a jacketing tube 231 is also fixed via another chuck 257 to the lathe. The core-rod 251 is allowed to slowly descend until it is inserted through an open end into the jacketing tube 231.

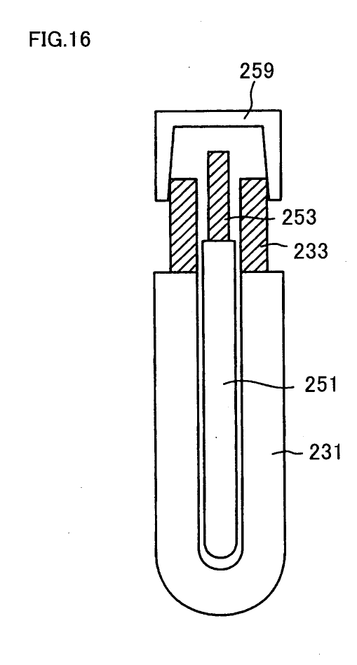

Next, for example, as shown in FIG. 16, the jacketing tube 231 receiving the insertion of the core-rod 251 is removed from the lathe, and a cap 259 is applied to the free end of the supporting tube 233. Then, in the same manner as described above, the assembly is immersed in an aqueous solution of hydrofluoric acid. Then, the assembly is transferred into another tank filled with purified water for washing roughly, and exposed to a shower of purified water to be rinsed, and then to compressed air so that water droplets are blown off, and is left dried. If it is found during the insertion step that the degree of the contamination of a jacketing tube is little, the cleaning step may comprise only rinsing with a shower of purified water and drying.

Wrapping the outer surface of a jacketing tube with a film after cleaning will minimize the risk of renewed contamination of the outer surface of the jacketing tube, and prevents contamination during the insertion of a core-rod or during handling including transportation. However, the protective film itself may be contaminated with foreign matters. To meet such situation, it is advisable to clean a jacketing tube just before fiber-drawing. This is particularly important for the fiber-drawing which requires the outer surface of a jacketing tube to have a high degree of purity.

Needless to say, either the cleaning step shown in FIG. 13 or the cleaning step shown in FIG. 16 may be carried out independently, or the former may be followed by the latter.

The present invention further provides a method for preparing a preform of an optical fiber, in the method for manufacturing an optical fiber comprising the steps of forming a core-rod, inserting the core-rod into the central cavity of a jacketing tube prepared separately, and pulling a drawn end of the glass assembly while heating its tip to collapse the jacketing tube with the core-rod, characterized by inserting the core-rod into the jacketing tube such that the interval between the outer diameter of the core-rod and the inner diameter of the jacketing tube be 1.0 to 10.0 mm.

According to the present invention, in the method for manufacturing an optical fiber in which a core-rod is formed, a jacketing tube is employed to form as a cladding portion, and the two glass elements are simultaneously subjected to heating and pulling to be collapsed, it is possible to reduce the occurrence of damages which may be brought when the the core-rod is inserted into the jacketing tube, and thus to prevent the reduction of the yield.

According to the present invention, it is possible to reduce the occurrence of flaws which may result from frictions between the outer surface of a core-rod and the inner surface of a jacketing tube during the insertion of the former into the latter by adjusting the interval between the outer diameter of the core-rod and the inner diameter of the jacketing tube to be in the range of 1.0 to 10.0 mm. It is also possible to minimize the core eccentricity of a resulting optical fiber.

FIG. 15 is a diagram for showing how a core-rod is inserted into a jacketing tube in a manner as described above. The arrow in the figure indicates the direction of insertion. The inner surface of the jacketing tube is free from the contamination by foreign matters and is kept uniformly smooth. The jacketing tube is set to a lathe for glass working, and its one end is exposed to flame from an oxygen/hydrogen burner to be sealed, and a supporting silica glass tube is attached by welding to the unsealed end of the jacketing tube.

According to the present invention, an end of a jacketing tube and an end of a supporting tube are heated by using oxygen/hydrogen flame to be melted and welded. The two melted ends are pressed together to be welded. The inner surface of welded joint is shaped such that the interval between the outer diameter of a core-rod and the inner diameter of the jacketing tube is in the range of 1.0 to 10.0 mm. The shaping may be achieved by using, for example, a trowel.

Namely, an end of a jacketing tube and an end of a supporting tube are heated by using oxygen/hydrogen flame to be melted, and the two melted ends are brought into contact with each other to be welded. Then, the inside of the welded end is shaped by using a trowel such that the interval between the outer diameter of a core-rod and the inner diameter of the jacketing tube is in the range of 1.0 to 10.0 mm. The shaping will reduce the occurrence of flaws resulting from frictions during the insertion of the core-rod into the jacketing tube.

Furthermore, according to the present invention, the supporting tube is preferably made of natural silica glass. Use of natural silica glass enables the production cost to be reduced.

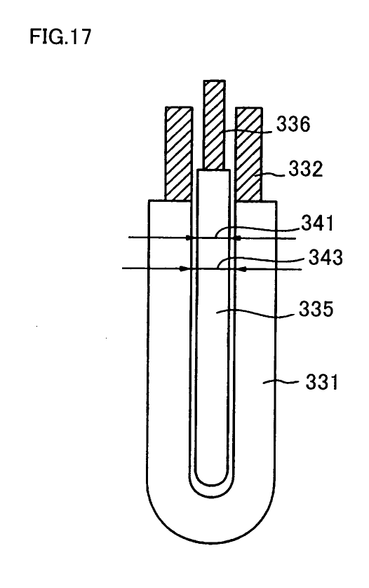

FIG. 17 is a schematic view for showing how a core-rod 335 is housed in a jacketing tube 331, after being inserted as described above. Incidentally, in order to obtain an optical fiber having specified characteristics, the ratio of the outer diameter of a jacketing tube 331 to its inner diameter is determined by the refractive index profile of a core-rod.

If a jacketing tube 331 and/or a core-rod 335 are crooked before insertion, or if a core-rod 335 is inclined with respect to a jacketing tube 331, the core-rod 335 may be rubbed against the inner surface of the jacketing tube. The risk of rubbing will increase as the interval between the two glass elements is narrowed, and the length of two glass elements is increased. To lower the risk, the interval between a core-rod and jacketing tube should be in the range of 1.0 to 10.0 mm.

To ensure that the interval between the two glass elements is in the range of 1.0 to 10.0 mm, preferably, the core-rod and the jacketing tube are finely processed in advance to have specified dimensions so that when they are combined, a desired interval is produced between the two elements.

According to the present invention, core-rod 335 and jacketing tube 331 are designed such that, when the former is inserted into the latter, the interval between the outer diameter 341 of the core-rod and the inner diameter 343 of the jacketing tube is in the range of 1.0 to 10.0 mm.

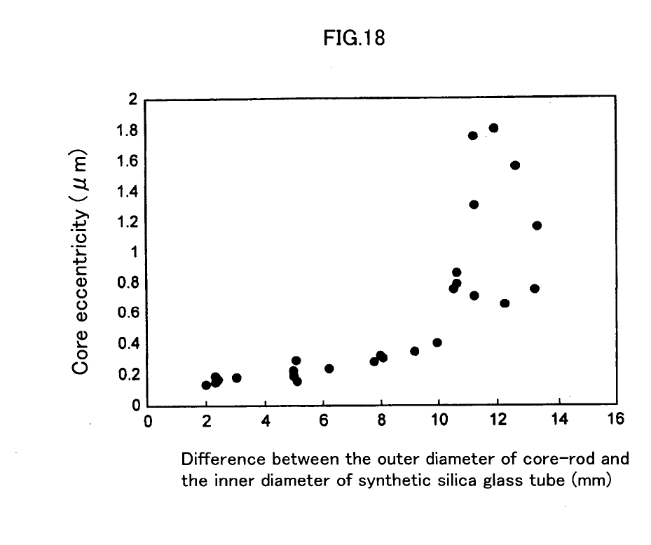

FIG. 18 shows relationship of the core eccentricity with the difference between the outer diameter of core-rods and the inner diameter of jacketing tubes. The graph shows that the core eccentricity increases with the increase of the interval (gap).

If the interval in question has a width below 1 mm, undesirably a core-rod will damage the inner surface of a jacketing tube during its insertion into the latter. On the contrary, if the interval in question has a width over 10 mm, the core eccentricity of a resulting optical fiber will be undesirably large. For a given glass assembly, its interval may be determined by taking any desired cross-section of the assembly, because a core-rod is inserted into a jacketing tube in parallel with each other.

The present invention further provides a method for supporting a preform of an optical fiber, in the method for manufacturing an optical fiber comprising the steps of heating/melting an end of a preform of an optical fiber composed of a jacketing tube receiving a core-rod in its central cavity, and pulling the end to collapse the jacketing tube with the core-rod, characterized by attaching a supporting tube having a larger inner diameter than does the inert end of the jacketing tube, and inserting the core-rod into the jacketing tube by way of the supporting tube.

According to the present invention, in the method for manufacturing an optical fiber comprising the steps of preparing a central portion including a core-rod, employing a jacketing tube which will form a cladding portion, and collapsing the jacketing tube with the central portion by heating performed simultaneously with fiber-drawing, it is possible to increase the efficiency of the work involving the insertion of core-rods into jacketing tubes. Moreover, if a preform is set to a fiber-drawing equipment, and its tip is pulled, while being heated/melted, into a thin fiber according to the present invention, the resulting optical fiber will exhibit satisfactory dimensions.

Furthermore, according to the present invention, a supporting tube is attached to an inert end of a jacketing tube for ease of handling, the supporting tube having a larger inner diameter than does the jacketing tube. This reduces the occurrence of damages that might be brought about, when a core-rod is inserted into a jacketing tube, by rubbing the outer surface of the core-rod against the inner surface of the jacketing tube. Also, even if a supporting rod attached to a core-rod is short, it is possible to insert the core-rod into a jacketing tube to a desired depth without being disturbed by a holding device. Therefore, when the core-rod is inserted into and housed in the jacketing tube, the supporting rod attached to the core-rod does not protrude too much from the jacketing tube, and thus handling of the glass assembly is easy.

Usually, fiber-drawing is carried out by using an electric furnace incorporating a carbon-resistance heater. However, if oxygen is present in the furnace heated to a high temperature, it will react with a material constituting the furnace to burn it. To prevent this inconveniency, an inert gas instead of air is allowed to enter the furnace. Generally, an inert end of a jacketing tube is jointed to an end of a supporting tube that serves as a handle. When, at a final phase of fiber-drawing, the jointed end of the supporting tube enters into the furnace, and the outer diameter of the glass assembly changes abruptly, the pressure within the furnace also changes abruptly which causes gas currents in the furnace to be agitated. This in turn causes the temperature distribution within the furnace to fluctuate that may lead to the diameter fluctuation of the fiber.

To avoid this inconveniency, the invention is characterized by preparing a jacketing tube and a supporting tube such that their outer diameters satisfy a specified relationship with respect to each other. Although they are processed in advance to have specified outer diameters, their outer diameters may fall out of the specified ranges after they have been joined together. If such disorder occurs, it is desirable to shape the joint by machining or flame-heating such that the joint has a specified outer diameter.

Attachment of a supporting tube to a jacketing tube brings about other incidental advantages. The supporting tube has a thinner wall, and lighter weight, and thus allows the reduction of purchase cost. It also facilitates handling. If the supporting tube is made of natural silica glass, further reduction of the production cost will be possible. Since the supporting rod to be attached to the core-rod is also shortened, it will contribute to the further reduction of production cost.

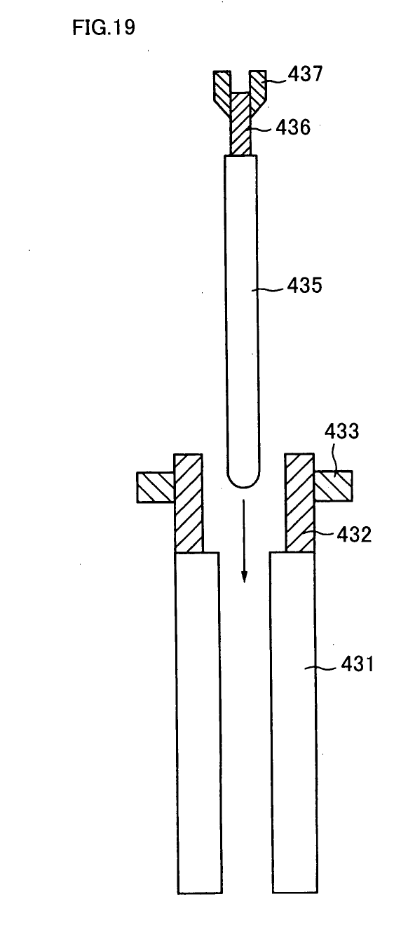

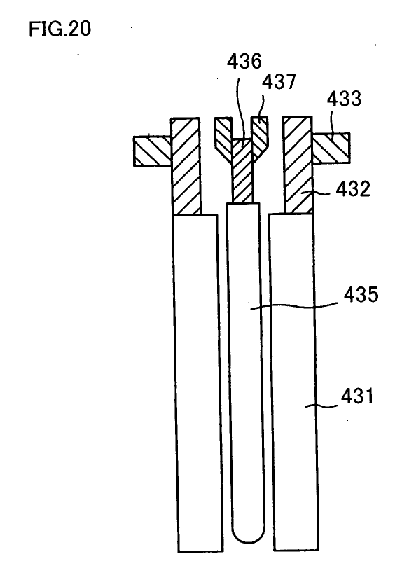

FIGS. 19 and 20 give diagrams for showing how a core-rod is inserted into a jacketing tube according to the present invention. The arrow in FIG. 19 indicates the direction of insertion. Incidentally, in order to obtain an optical fiber having specified characteristics, the ratio of the outer diameter of a jacketing tube to its inner diameter is determined by the refractive index profile of a core-rod. Usually, the outer diameter of a core-rod 435 is smaller than the inner diameter of a jacketing tube 431.

Before a core-rod 435 is inserted into a jacketing tube 431, if the jacketing tube 431 and/or the core-rod 435 are crooked, or if the core-rod 435 is inclined with respect to the jacketing tube 431, the core-rod 435 may be rubbed against the inner surface of the jacketing tube 431. The risk of rubbing will increase as the interval between the two glass elements is reduced, and the lengths of the two glass elements are increased.

Incidentally, the inner diameter of a supporting tube 432 does not directly affect the characteristics of a resulting fiber. Because of this, it is possible to make the inner diameter of a supporting tube 432 than that of a jacketing tube 431 without affecting the characteristics of a resulting fiber, and thus to reduce the risk of bringing the outer surface of a core-rod into contact with the inner surface of a jacketing tube during the insertion of the former into the latter. This facilitates involved work and thus contracts the time required for the work.

Since, according to the present invention, it is possible to enlarge the inner diameter of a supporting tube 432 as compared with that of a jacketing tube, even a holding device 437 for holding a supporting rod 436 of a core-rod 435 can be inserted in the interior of the supporting tube 432, that is, the core-rod 435 including the supporting rod 436 can be inserted in the interior of the jacketing tube 431, and thus protrusion of the supporting rod 436 attached to the core-rod 435 from the jacketing tube can be safely prevented, which facilitates subsequent handling of this glass assembly.

Alternatively, the outer diameter of a supporting tube 432 may be made equal to or slightly less than that of a jacketing tube 431. If a glass assembly incorporating such a supporting tube is subjected to fiber-drawing, even if the jointed portion of the supporting tube 432 enters into a furnace at a final stage of fiber-drawing, it will not disturb gas currents within the furnace. As a result, it is possible to prevent the diameter fluctuation of a resulting optical fiber.

Although the outer diameter of a jacketing tube 431 is processed in advance to be the same with that of a supporting tube 432, the outer diameters may undergo fluctuations at the joint when the supporting tube is joined to the jacketing tube. If such disorder occurs, it is desirable to shape the joint by machining or flame-heating such that the joint has a uniformly flat profile.

Enlarging the inner diameter of a supporting tube 432 enables the wall thickness of the supporting tube 432 to be reduced. As a consequence, the supporting tube 432 becomes light that leads to the reduction of purchase cost, and facilitates handling.

Yet another feature of the present invention is to employ natural silica glass as a material of the supporting tube. If the supporting tube is made of natural silica glass, further reduction of the production cost becomes possible. Furthermore, according to the present invention, it is possible to reduce the length of the supporting rod for supporting a core-rod, which leads to the reduction of its weight and is effective in reducing cost.

The present invention will be further explained with reference to FIGS. 19 and 20. The inner surface of a jacketing tube 431 is free from the contamination of any foreign matter and is kept uniformly flat in profile. The silica glass tube is set to a glass-working lathe, and a supporting tube 432 made of silica glass is attached by welding to an inert end of the tube.

According to further another aspect of the present invention, an end of a jacketing tube and an end of a supporting tube are heated by using oxygen/hydrogen flame to be melted, and the two melted ends are brought into contact with each other to be welded. Then, shaping of the joint is achieved using a trowel such that the outer diameter of the joint is practically the same with that of the glass tube.

Namely, when an end of a jacketing tube and an end of a supporting tube are heated by using oxygen/hydrogen flame to be melted, and the two melted ends are brought into contact with each other to be welded, it is desirable to shape the joint using a trowel such that the outer diameter of the joint is practically the same with that of the glass tube.

According to the present invention, in the method for manufacturing an optical fiber comprising the steps of setting a preform to a fiber-drawing equipment and pulling an end of the preform while it is melted by heating, into a thin fiber, it is possible to reduce the duration of initial unstable drawing condition lasting from the onset of pulling till the establishment of stable drawing, and reducing the length of a defective fiber portion produced during the unstable condition.

According to the present invention, it is desirable to collapse an end of a glass assembly constituting a preform of an optical fiber by heating it in a furnace of a fiber-drawing equipment, and then to initiate fiber-drawing by pulling the end. Namely, according to the present invention, core-rods, and jacketing tubes which will form cladding portions are prepared independently of each other. A core-rod is inserted into a jacketing tube made of synthetic silica glass so that a resulting fiber will have a cladding layer made of synthetic silica glass, and an end of the glass assembly is collapsed before the end is pulled by the fiber-drawing equipment. This ensures the reduction of cost.

According to the present invention, the drawn ends of a core-rod and jacketing tube are processed in advance to have a desired shape, the former is inserted into the latter, and the drawn ends brought into contact with each other are collapsed by heating. Thus, it is easy to start fiber-drawing. Moreover, if the central cavity of a jacketing tube and the drawn end of a core-rod are processed in advance to have a desired shape, it is possible to reduce the occurrence of failures which might be brought about during fiber-drawing.

Incidentally, a fiber-drawing equipment comprises a furnace, resin coater, resin curing unit, and take-up capstan arranged vertically. A preform is melted in the furnace, and a resulting optical fiber is taken up continuously by the capstan. For fiber-drawing, it is necessary to pull down a starting end (tongue) from the glass preform. For this purpose, a preform is placed in the furnace which is then heated to melt a tip of the preform, and the tip is allowed to fall because of its own weight, then the tip is received. The starting end (tongue) preferably has a conical shape with a weight on its top.

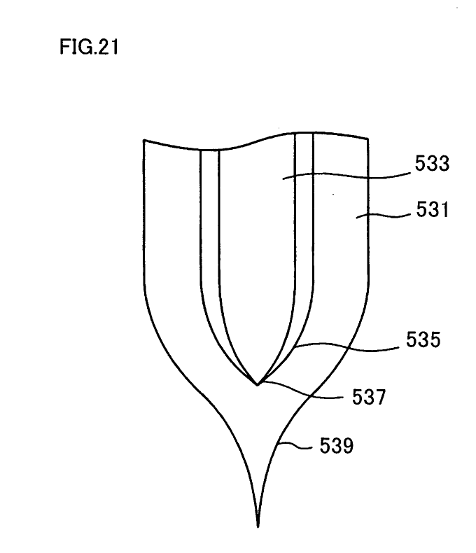

FIG. 21 shows an illustrative example of the present invention. FIG. 21 shows a core-rod 533 whose one end is tapered and a jacketing tube 531 whose one end has a taper 535. At the drawn end of the jacketing tube 531 there is a tapered profile 539 which is produced by heating. If the drawn end of a jacketing tube 531 is tapered and sealed, the duration until the onset of stable fiber-drawing is shortened, and thus the length of unusable fibers which might be produced during unstable drawing condition can be reduced.

It is desirable to seal the drawn end of a jacketing tube 531 simultaneously with its tapering, by pulling the drawn end of the jacketing tube 531 which is heated so that the open end is contracted by pulling and closed. In addition, if a core-rod 533 is processed so as to have a tapered end, the drawing condition reaches to the stable condition earlier than the case of a fiber prepared from a non-tapered preform, because the core/cladding ratio of the processed core-rod so as to have a tapered portion is close to the desired one of the effective portion of the preform.

The present invention further provides a method for aligning a preform of an optical fiber, in the method for manufacturing an optical fiber comprising the steps of heating/melting an end of a preform of an optical fiber composed of a jacketing tube receiving a core-rod in its central cavity, and pulling the end to collapse the jacketing tube with the core-rod while the pressure of the gap between the jacketing tube and the core-rod is reduced, characterized by tapering the drawn end of the jacketing tube in advance so that the end is sealed when pulled, and providing an annular spacer to the glass assembly so that the core-rod is concentrically arranged with respect to the jacketing tube.

According to the present invention, in the method for manufacturing an optical fiber comprising preparing a central portion containing a core-rod, employing a jacketing tube which corresponds with a cladding portion, and collapsing the two glass elements by pulling them while they are heated, the core-rod, after being inserted into the jacketing tube, is adjusted to be arranged concentrically with respect to the jacketing tube. This enables the core eccentricity of a resulting fiber to be reduced.

According to the present invention, after a core-rod is inserted into a jacketing tube, the core-rod is adjusted in positioning to be at the center of the jacketing tube. This ensures that the resulting fiber has satisfactory geometrical characteristics.

Incidentally, in order to obtain an optical fiber having specified characteristics, the ratio of the outer diameter of a jacketing tube to its inner diameter is determined by the refractive index profile of a core-rod. Naturally, the outer diameter of a core-rod is smaller than the inner diameter of a jacketing tube. Therefore, if a jacketing tube or a core-rod is crooked, or if a core-rod is inclined with respect to a jacketing tube, the core of a resulting fiber will diverge from the center of the fiber itself.

A fiber-drawing equipment comprises a furnace, resin coater, resin curing unit, and take-up capstan arranged vertically. A preform is melted in the furnace, and a resulting optical fiber is taken up continuously by the capstan. Since the units constituting the fiber-drawing equipment are arranged vertically, a preform is placed in the furnace standing vertically. A core-rod inserted into a jacketing tube, not being fixed to the jacketing tube, rests on the inside of the sealed end of the jacketing tube.

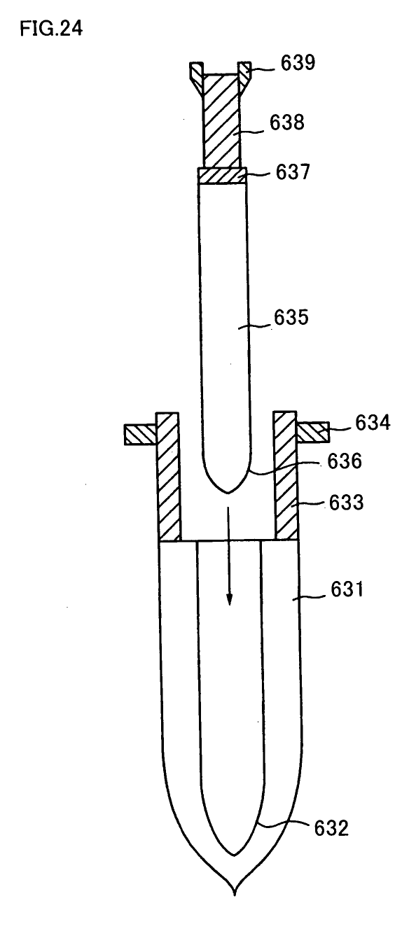

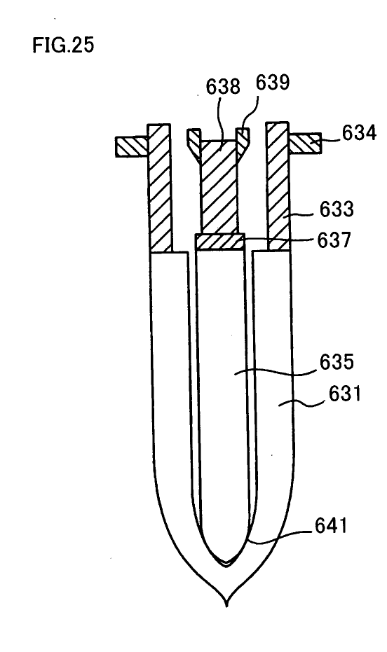

FIG. 24 shows an embodiment of the present invention. FIG. 24 is a diagram for showing how a core-rod is inserted into a jacketing tube in one embodiment of the present invention. FIG. 25 is a diagram for showing how a core-rod is inserted into and housed in a jacketing tube. FIGS. 24 and 25 show a core-rod 635 whose one end has a taper 636 and a jacketing tube 631 whose one end has a taper 632. As described above, the units of a fiber-drawing equipment are arranged vertically, and a preform is set vertically in the furnace. Since the core-rod 635 inserted into the jacketing tube 631, not being fixed to the jacketing tube 631, comes into contact with the inner surface of the jacketing tube 631 at a tapered zone 641.

According to the present invention, the jacketing tube 631 has, on its drawn end, a taper 632, the core-rod 635 has, on its drawn end, a taper 636, and the core-rod 635 comes into contact with the jacketing tube 631 at a circular zone 641 of the taper 632. Thus, it is possible to align the central longitudinal axis of the core-rod 635 with that of the jacketing tube 631.

With regard to the inert ends of the two glass elements, a spacer is used such that the central longitudinal axis of the core-rod 635 coincides with that of the jacketing tube 631. Use of a spacer makes it possible to minimize the core eccentricity, that is, to maintain the core-rod 635 at the center of the jacketing tube 631 over the full length of the latter.

According to the present invention, the jacketing tube 631 is processed to have, on one end, a taper 632 whose end is sealed. Similarly, an end of the core-rod 635 is processed to have a taper 636. A spacer is provided to the glass assembly so that, at any given cross-section of the assembly, the core-rod 635 is arranged concentrically with respect to the jacketing tube 631. Alignment of the central longitudinal axis of the core-rod 635 in the form of a column with the central longitudinal axis of the jacketing tube 631 in the form of a cylinder provides a glass assembly in which at any given cross-section, the core-rod 635 is arranged concentrically with respect to the jacketing tube 631. This arrangement makes it possible to minimize the core eccentricity of a resulting fiber.

According to the present invention, a silica glass supporting tube 633 is attached to an inert end of a glass tube 631 whose drawn end is tapered, a silica glass supporting rod 638 is attached to an inert end of a core-rod 635 whose drawn end is tapered, and a spacer is provided into a interval between the supporting tube 633 and the supporting rod 638.

The present invention will be further explained with reference to FIG. 25. It is possible to align the central axis of a core-rod 635 with that of a jacketing tube 631 by inserting a wedge-like spacer into the gap between the upper end of the core-rod 635 and the upper end of the jacketing tube 631, and fixing the spacer to the upper end of the jacketing tube, on the assumption that the glass assembly or preform is arranged vertically with its drawn end downward. However, it is desirable to obtain a fiber from as long an effective portion of a preform as possible. For this purpose, it is desirable to attach a supporting tube 633 to the inert end of a jacketing tube 631 and a supporting rod 638 to the inert end of a core-rod 635, and to align the core-rod 635 with the jacketing tube 631 by adjusting the supporting rod 638 with respect to the supporting tube 633.

For this purpose, it is necessary to align the central axis of the supporting rod 638 attached to a core-rod 635 with that of the supporting tube 633 attached to a jacketing tube 631. To achieve this, according to the present invention, a supporting tube 633 is attached to a jacketing tube 631 such that the inner surface of the former is concentrically arranged with respect to the inner surface of the latter. Similarly, a supporting rod 638 is attached to a core-rod 635 such that the outer surface of the former is concentrically arranged with respect to the outer surface of the latter. Then, a spacer is provided to the glass assembly to ensure that the outer surface of the supporting rod 638 or of the core-rod 635 is concentrically arranged with respect to the inner surface of the supporting tube 633.

According to the present invention, a supporting base 637 is provided coaxially to a supporting rod 638: the supporting rod base 637 has a diameter which is larger than that of supporting rod 638 for arresting a spacer, but is nearly equal to that of core-rod 635. Of course, the supporting rod base 637 may be omitted and the supporting rod 638 may be directly attached to a core-rod. Arresting a spacer on a supporting rod may be achieved, for example, by tapering a part of the surface of the supporting rod, thrusting a spacer along the supporting rod with its central opening, and placed on the tapered portion of the supporting rod.

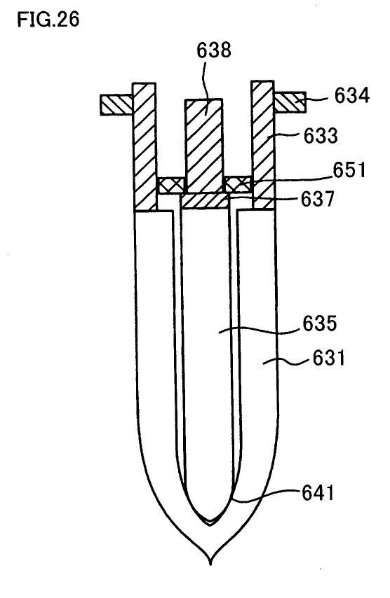

FIG. 26 is a diagram for showing how a spacer is inserted according to an embodiment of the present invention. A spacer 651 is inserted within the supporting tube 633 attached to a jacketing tube 631 by inserting a supporting rod 638 attached to a core-rod 635 into its central opening until it is brought into contact with the upper end of a supporting rod base 637. This causes the central longitudinal axis of the core-rod 635 to coincide with that of the jacketing tube 631 to ensure secure alignment.

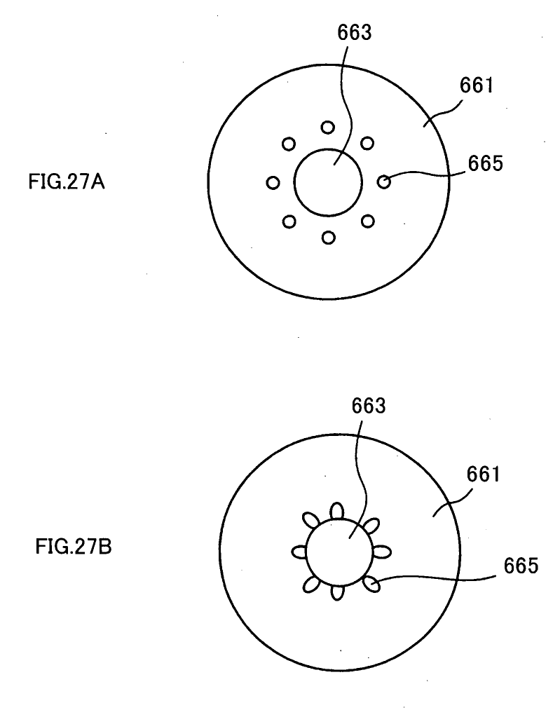

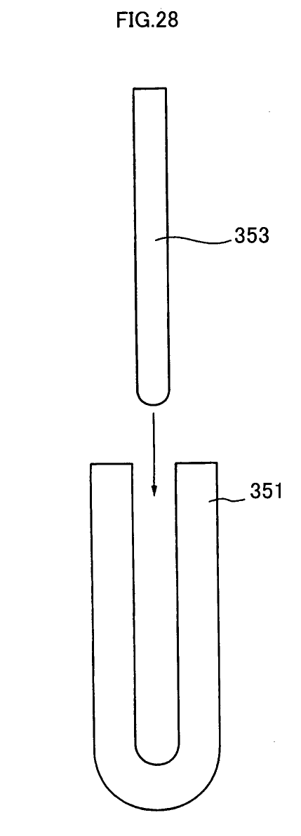

FIG. 27 shows two exemplary spacers according to the present invention. The spacer 661 has a central opening 663 with a circular cross-section whose diameter is nearly equal to the outer diameter of a supporting rod to which it is applied. The spacer 661 has a circular outer surface whose diameter is nearly equal to the inner diameter of a supporting tube into which it is inserted. The spacer 661 has a width of, for example, 10 mm in this particular example, but the width may be freely determined, as long as the spacer can satisfy its assigned function according to the present invention.

During fiber-drawing, it is necessary to aspirate air from the hollowness of a jacketing tube. Thus, the spacer must have a hole(s). The hole 665 may consist of a series of circular or ellipsoidal holes as shown in FIGS. 27A and 27B. However, the shape of each hole is not limited to any specific one, as long as the total open area satisfies a given requirement. The material of a spacer is preferably silica glass because of its durability to high temperature. This is because the spacer is exposed to high temperatures during fiber-drawing.

The present invention further provides a method for processing an end of a preform of an optical fiber, in the method for manufacturing an optical fiber comprising the steps of heating/melting an end of a preform of an optical fiber composed of a jacketing tube receiving a core-rod in its central cavity, and pulling the end to collapse the jacketing tube with the core-rod while the pressure of the interval between the jacketing tube and the core-rod is reduced, characterized by tapering the drawn end of the jacketing tube in advance so that the end is sealed when pulled, and tapering the drawn end of the core-rod, the tapering of the two ends being performed such that the tapered angle of the core-rod is larger (more blunt) than the tapered angle of the jacketing tube but sufficiently small to allow the tapered end of the core-rod to come into contact with the tapered end of the jacketing tube.

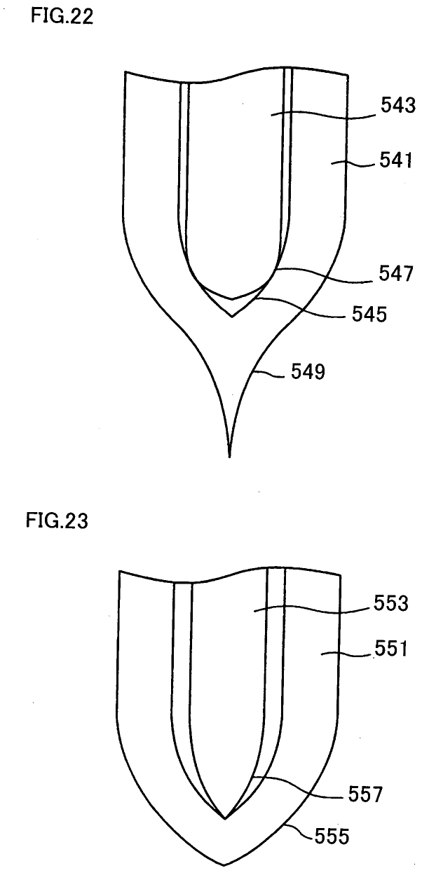

The units of a fiber-drawing equipment are arranged vertically, and thus a preform is set vertically in the furnace. Since a core-rod 533 inserted into a jacketing tube 531, not being fixed to the jacketing tube 531, comes into contact with the sealed bottom of the jacketing tube 531 as a result of gravity. When the tip is heated, the portions of the two elements brought into contact with each other are melted to be welded, and then fiber-drawing is initiated. According to the present invention, preparatory tapering of the drawn ends of a jacketing tube 531 and a core-rod 533 is preferably performed such that the tapered angle of the core-rod 533 is larger than that of the jacketing tube 531, but is sufficiently small to allow the tapered end of the core-rod 533 to come into contact with the tapered end of the jacketing tube 531 at a circular zone 537 as shown in FIG. 22. The taper used herein means a shape whose profile exhibits a gradual reduction in width, and the profile may have a linear, slowly concave or convex gradient.

If a jacketing tube is thinned on its drawn end, and the end is further contracted to be sealed, and a core-rod is also contracted on its drawn end to have a sharp end, and the core-rod is inserted into the jacketing tube, the core/cladding ratio of the tapered portion of the resulting assembly will be close to a specified one. Such an assembly or preform is most suitable for starting fiber-drawing. However, the tapered end of the core-rod may strike against the inner wall of the jacketing tube, or it may contact with the inner surface of the narrow region of the tapered portion of the jacketing tube. Then, at an initial phase of melting, the tip of the jacketing tube may not be precisely collapsed.

Then, the welded joint may undergo irregularities in shaping, or may entrap an air bubble, or the drawn end of a glass assembly may be welded with a jacketing tube being slanted with respect to a core-rod which causes the core eccentricity of a resulting fiber. To avoid this, preferably, the drawn end of a core-rod is tapered such that its tapered angle is slightly more blunt than the tapered angle of a jacketing tube. Then, when the core-rod is inserted into the jacketing tube, its tapered end stably contacts with the tapered end of the latter along the periphery of a circle. Because of this, it is possible to quickly complete the welding which is performed prior to fiber-drawing, allow the welded portion to be stably shaped, and ensure stable fiber-drawing.

FIG. 22 shows another embodiment of the present invention. FIG. 22 shows a core-rod 543 whose one end has a taper close, in shape, to a hemisphere, and a jacketing tube 541 whose one end has a taper 545. At the drawn end of the jacketing tube there is a tapered profile 549 which is produced by heating.

According to this embodiment, it is desirable to taper the drawn ends of a jacketing tube 541 and a core-rod 543 such that the tapered angle of the core-rod 543 at a contact zone 547 is larger (more blunt) than that of the jacketing tube 541 at its end. Thus, the drawn end of the core-rod is processed to have a taper whose tip angle is more blunt than the angle of the internal tapered cavity of the jacketing tube 541. Through this arrangement, it is possible, when the core-rod 543 is inserted into the jacketing tube 541, to allow the core-rod to stably contact with the tapered inner surface of the jacketing tube in the form of a circle or a circular band 547. Because of this, it is possible to quickly and stably complete the welding which is performed prior to fiber-drawing.

Incidentally, as the drawn end of a core-rod becomes more hemispherical, its contact zone comes closer to the base of the tapered inner surface of a jacketing tube into which the core-rod is inserted. Then, there arises such a wide blank space between the drawn end of the core-rod and the internal tapered surface of the jacketing tube that a considerable time will be required until starting the fiber-drawing. Thus, it is desirable to process the drawn end of a core-rod such that it has a most proper shape.

### EXAMPLE

The present invention will be described more in detail below by means of examples, but it should not be understood that the present invention is limited to those examples.

In the examples below, the manufacture of single mode optical fibers will be described in which a core-rod containing part of a cladding is prepared by VAD method, and a cladding is overlaid to the core-rod by using a silica glass tube. The core-rod may have a different refractive index profile, and be prepared by a different method.

### Example 1

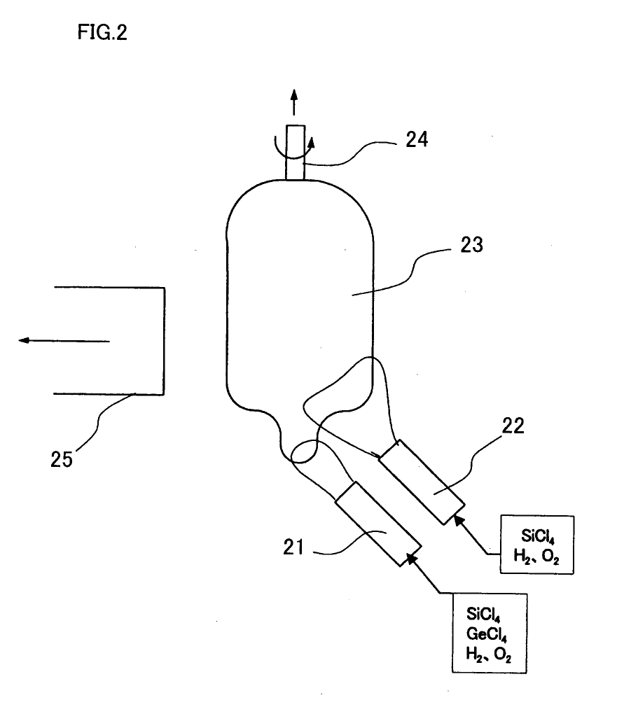

As shown in FIG. 2, VAD consists of discharging vaporized silicon tetrachloride and germanium tetrachloride together with oxygen and hydrogen via a core-preparing burner 21 consisting of a multiple pipe structure, igniting the gas mixture to burn to allow thereby a hydrolysis reaction to occur in the resulting flame, producing particulate synthetic silica glass, and depositing the particles onto a seed rod 24 to obtain a porous core soot 23. To obtain a preform stable in characteristics, an additional burner 22 is provided above the core burner 21 which discharges silicon tetrachloride and oxygen/hydrogen to allow the gas mixture to react, and deposit the particulate synthetic silica glass onto the core soot to provide a part of the cladding layer around it. The particulate synthetic silica glass is heated to around 1500 to 1600° C. to produce a transparent glass body. With regard to a single-mode optical fiber, its core/cladding ratio is about 1:13. It is difficult according to VAD method to obtain a preform having a thick cladding layer. A glass body obtained by VAD method in this example had a core/cladding ratio of 1:4.5. A glass body containing a core was obtained in this manner.

The glass body was then elongated to have an outer diameter of 30 mm. This was inserted into a silica glass jacketing tube having an outer and inner diameters of 90 and 33 mm, respectively, which was prepared separately.

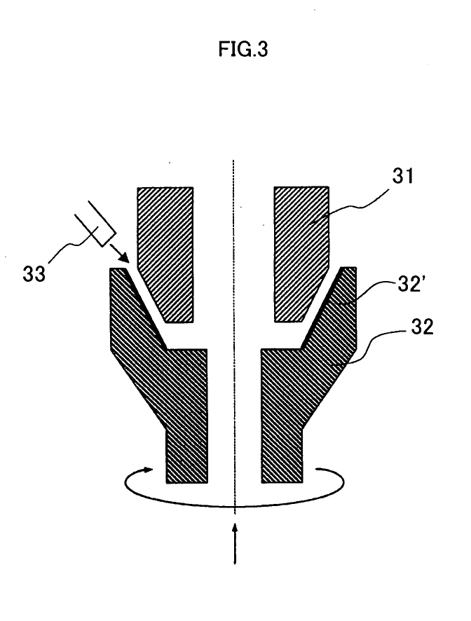

Tip abrasion was achieved as shown in FIG. 3: a grinding stone 32 whose cutter is made of diamond powder was rotated, and its cutter was brought into contact with the outer rim of a jacketing tube 31, to shape the rim like the profile of the grinding stone 32. Abrasion was achieved while cooling water 33 was poured over the abraded portions to prevent the heating thereof. The jacketing tube 31 was fixed vertically, and the grinding stone 32 was allowed to ascend slowly towards the tube. Preferably, the grinding stone 32 has a sink-hole at the center of its bottom, because then debris and cooling water 33 are allowed to flow through the hole to outside, and contamination of the tube by the debris can be minimized.

Incidentally, to bore a hole through a rod, a grinding stone shaped like a cone was used similarly.

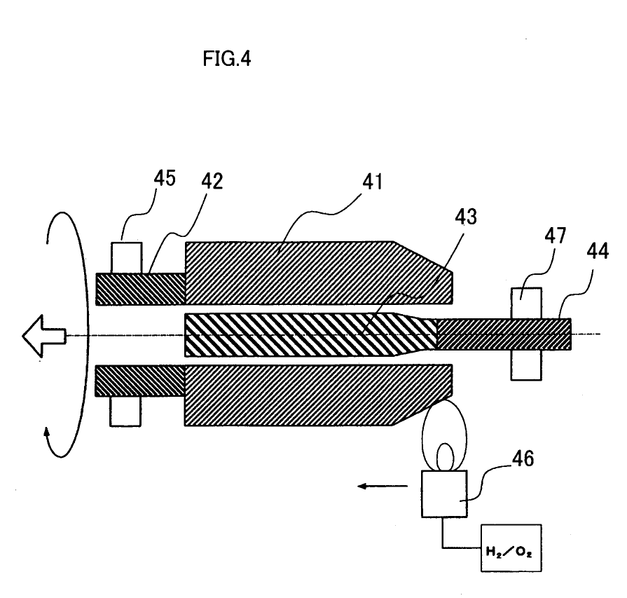

As shown in FIG. 4, a supporting tube 42 was attached by welding to an inert end of a jacketing tube 41 whose drawn end has been tapered, and the jacketing tube 41 was attached to a glass-working lathe by means of the supporting tube 42 whose distal end is held by a chuck 45 of the lathe. The distal end of the supporting tube 42 is connected to a vacuum pump, and the reducable condition of the pressure within the jacketing tube 41 was realized by means of aspirating air therein with the vacuum pump a supporting rod 44 was attached to a drawn end of a core-rod 43 which was processed in advance to have a specified dimension in the same manner as described above, and the core-rod 43 was similarly attached to the lathe by means of the supporting rod 44 whose inert end is held by another chuck 47 of the lathe. The core-rod 43 was then inserted into the jacketing tube 41. The chucks of the lathe were rotated, and the tip of the glass assembly was exposed to oxygen/hydrogen flame of the burner so that the drawn ends of the jacketing tube 41 and core-rod 43 were melted to be sealed. Then, the vacuum pump was switched on to reduce the pressure within the jacketing tube. If the vacuum pump were activated while the drawn end of the glass assembly was still open, the end might absorb foreign matters or entrap air bubbles. This situation must be carefully avoided. Then, the burner was moved so that the collapsing of the glass elements occurred over the full length of the glass assembly.

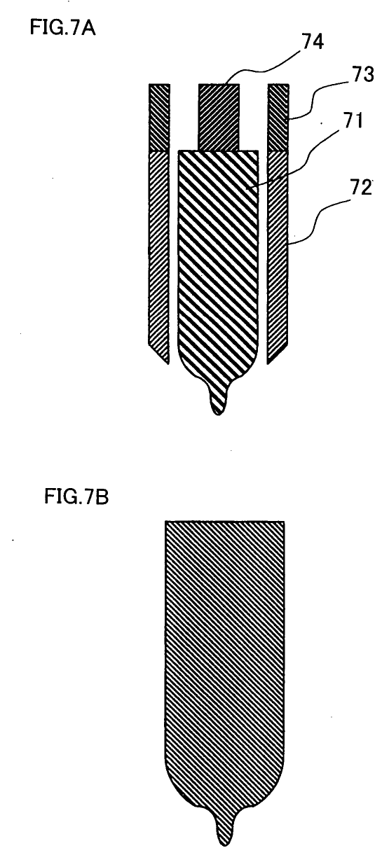

Thus, a core-rod and a jacketing tube as shown in FIG. 7A were collapsed into a preform as shown in FIG. 7B.

The preform was transferred to a fiber-drawing equipment where its tip was heated in a furnace to be melted. Then, the preform was extended on account of its own weight, the resulting thread was taken up by a take-up capstan and further extended into a fiber with a diameter of 125 μm, and the fiber was coated with a UV curable resin to give a coated fiber. If the preform did not receive tip processing, it required a considerable amount of time until it allowed the stable drawing condition of a fiber having a diameter of 125 μm and giving a specified core/cladding ratio. However, if the preform received tip processing according to the present invention, the duration of the initial unstable drawing phase was greatly reduced. The duration of unstable drawing phase which lasts from the onset of pulling till the appearance of stable meniscus profile is two to three hours when a conventional method is employed, but it was reduced to one hour when the inventive method was employed in this example, although the reduction of the duration varied more or less depending on the size of the test preform.

Breakage of fibers was sometimes observed in the fibers obtained by the above-described method. Metal particles were detected as a result of the analysis performed on the broken segments. It was thought that they were derived from particles separated from the grinding stone during abrasion. To meet this inconvenience, additional steps comprising cleaning preforms with a 5 wt % aqueous solution of hydrofluoric acid, rinsing them with purified water and drying them were introduced. This significantly reduced the occurrence of breakage. According to the present invention, an embodiment including these additional steps is desirable.

However, if a preform had its surface roughed as a result of cleaning in the acidic solution, and drawn into a thin fiber, the fiber might undergo diameter fluctuation and clog the dice orifice of the coater. To avoid this, the tip was subjected to machine-polishing. Then, the flaw was eliminated. Thus, according to the present invention, an embodiment including a tip polishing step is desirable.

### Example 2

As in Example 1, a supporting tube 83 was attached by welding to an inert end of a jacketing tube 82 whose drawn end has been tapered, and the jacketing tube 82 was attached to a processing lathe by means of the supporting tube 83 whose distal end is held by a chuck of the lathe as shown in FIG. 8A. To a drawn end of a core-rod 81 which was processed in advance to have a specified dimension, a supporting rod 84 was attached as in Example 1, and the core-rod 81 was similarly attached to the lathe. The core-rod 81 was then inserted into the jacketing tube 82. The chucks of the lathe were rotated as in Example 1, and the tip of the glass assembly was exposed to oxygen/hydrogen flame of the burner so that the drawn ends of the jacketing tube 82 and core-rod 81 were melted to be sealed. Then, a glass assembly incorporating the core-rod and jacketing tube whose tip was collapsed as shown in FIG. 8B was obtained. The glass assembly was then transferred to a fiber-drawing equipment where its tip was heated in an electric furnace. At the same time, the inert end of the supporting tube 83 was connected to a vacuum pump, and the vacuum pump was switched on to reduce the pressure within the jacketing tube. This enabled simultaneous execution of collapsing and fiber-drawing. By this method, the advantages brought about by tip processing were obtained as in Example 1.

### Example 3

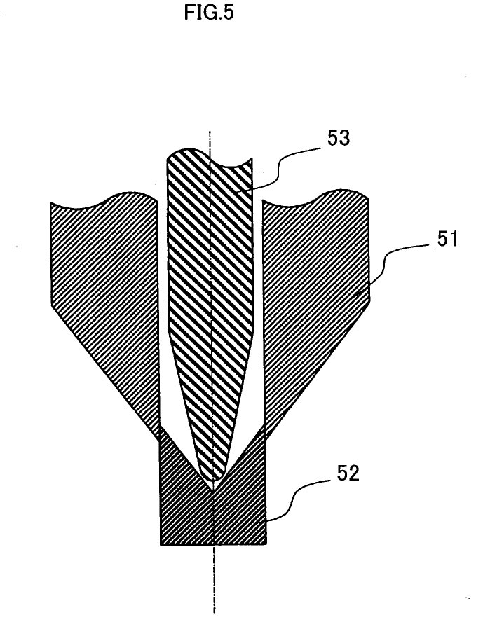

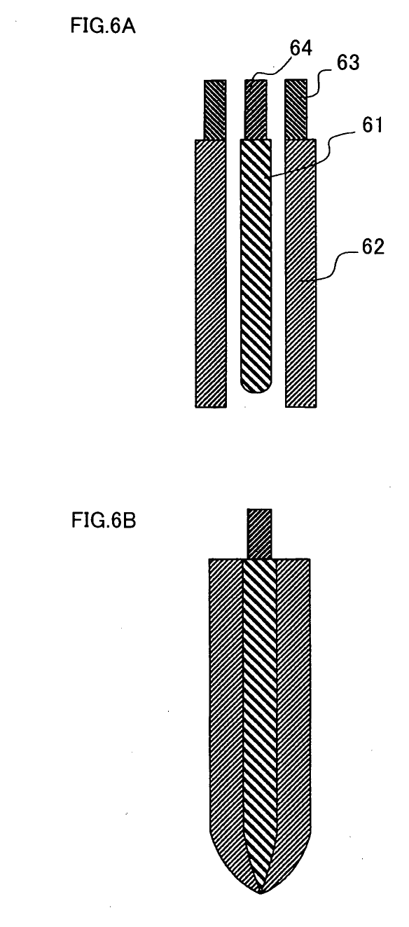

According to the method of Example 2, as shown in FIG. 29, a drawn end of a jacketing tube 82 has a straight inner surface while a drawn end of a core-rod 81 has a taper when the two ends are welded together just before the onset of fiber-drawing. Therefore, if the core-rod 81 and jacketing tube 82 are displaced longitudinally with respect to each other, the two drawn ends could not be successfully welded, because then the clearance between the two ends may be too large. To meet such situation, as shown in FIG. 9, a rod was prepared which had, on one end, a recess whose surface had a tapered profile, and this was called a jacketing tube sealing rod 95. Then, the rod 95 was placed with respect to the glass assembly such that the recess was positioned practically at the same level with the drawn ends of the core-rod 81 and jacketing tube 82 in a longitudinal direction. Except for this, the glass assembly was treated as in Example 2 to produce a preform of an optical fiber. FIG. 5 gives, in a cross-sectional view, the enlarged view for showing how the tip of the glass assembly was sealed. This improved the problem due to the too wide clearance, and when the tip of assembly whose profile was as indicated in FIG. 9B was pulled, stable fiber drawing sets in soon (about 10 to 20 minutes) after the onset of fiber-drawing. Also by this method, the advantages brought about by tip processing as observed in Example 1 were obtained.

### Example 4

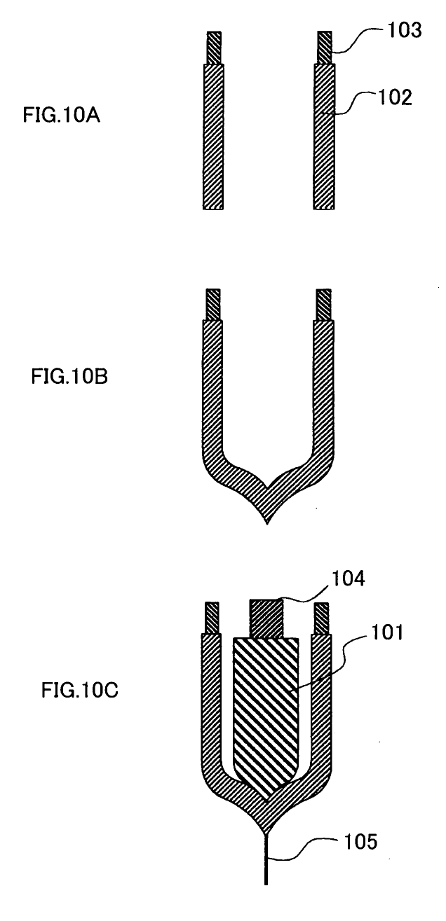

As shown in FIG. 10, an inert end of a jacketing tube 102 whose drawn end had been processed was set to a glass-working lathe as in Example 1. A drawn end of the jacketing tube 102 was exposed to oxygen/hydrogen flame, and its two ends ware slowly stretched. Then, the drawn end exhibited a tapered profile and was contracted in association. Finally, when the drawn end was cut by means of the flame, a tapered end was obtained as shown in FIG. 10B. A core-rod 101 was inserted into the jacketing tube 102, and a supporting tube 103 was attached to an inert end of the tube 102. The glass assembly was set to a fiber-drawing equipment. The assembly was slowly transferred into a furnace, and when the pressure within the jacketing tube 102 was reduced by means of a vacuum pump connected to the supporting tube 103, the ends of two glass elements were welded. Then, fiber-drawing was introduced to extend the end to obtain an optical fiber 105 as shown in FIG. 10C. The glass assembly was slowly transferred into the furnace as the fiber was taken up, and thus collapsing proceeded simultaneously with the thinning of the assembly. Also by this method, the advantages brought about by tip processing as observed in Example 1 were obtained.

### Example 5

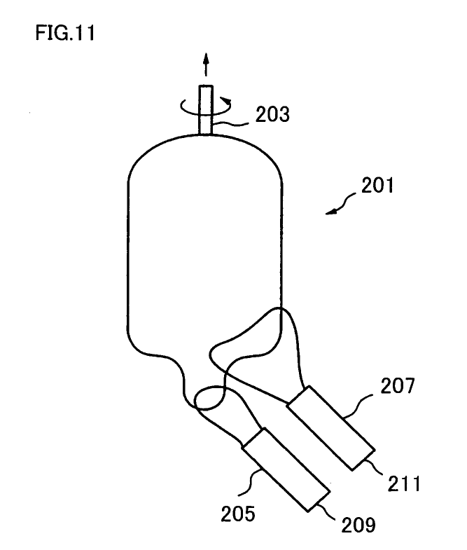

As shown in FIG. 11, VAD method consists of discharging a gas 209 comprising vaporized silicon tetrachloride (SiCl₄) and germanium tetrachloride (GeCl₄) together with oxygen (O₂) and hydrogen (H₂) via a core-preparing burner 205 consisting of a multiple pipe structure, igniting the gas to burn to allow thereby a hydrolysis reaction to occur in the resulting flame, producing particulate synthetic silica glass, and depositing the particles onto a seed rod 203 to obtain a porous core soot 201. The seed rod 203 together with the porous core soot 201 was rotated counterclockwise as indicated by an arrow in the figure, and the seed rod 203 itself was allowed to move in a direction as indicated by another arrow in the figure.

To obtain a core soot 201 stable in characteristics, an additional burner 207 was provided above the core burner 205 which discharged a gas 211 comprising silicon tetrachloride (SiCl₄), and oxygen (O₂) and hydrogen (H₂) to allow the gas to react, and deposited the particles onto the core soot to provide a cladding layer around it. The resulting porous material 201 was heated to around 1500 to 1600° C. to produce a transparent glass body. With regard to a single-mode optical fiber, its core/cladding ratio is about 1:13. A glass body obtained by VAD method in this example had a core/cladding ratio of 1:4.5. The glass body was then elongated to give a core-rod having an outer diameter of 30 mm.

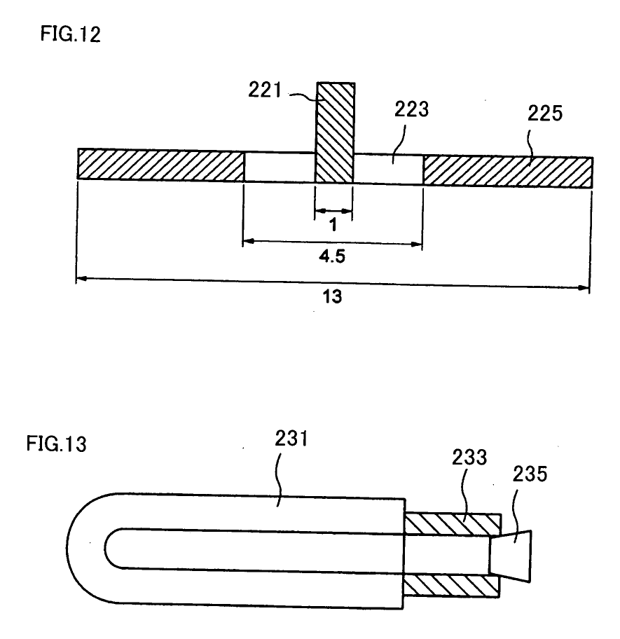

Separately, a silica glass tube having an outer and inner diameters of 90 and 33 mm, respectively, was prepared to serve as a jacket tube. This is because, when this jacketing tube is combined with the core-rod prepared as above, the resulting fiber will have a specified core/cladding ratio. FIG. 12 shows, in a cross-sectional view, a core-rod 223 containing a central portion 221 enclosed in a jacketing tube 225.

The numerals enclosed by divergent arrows in FIG. 12 represent the relative sizes of the involved components, that is, when the outer diameter of the central portion 221 is made 1, the outer diameter of the core-rod 223 corresponds to 4.5. On the other hand, the outer diameter of the jacketing tube 225 corresponds to 13, when the outer diameter of the central portion 209 is 1.

Incidentally, the inner surface of the jacketing tube was free from the adherence of foreign matters and its lengthwise profile was uniformly flat. The jacketing tube was set to a glass-working lathe, and, while one of the tips was exposed to oxygen/hydrogen flame, both of its ends were slowly pulled. Then, the end was melted/softened, and stretched to give a tapered profile. Finally, when the end was cut by flame-heating, it was sealed.

As shown in FIG. 13, to an inert end of the jacketing tube 231 whose drawn end had been sealed as above was attached a supporting tube 233 by welding. The supporting tube had outer and inner diameters of 90 and 70 mm, respectively. After being cooled, the jacketing tube was removed from the lathe, and a plug 219 made of silicon rubber was applied to the open end of supporting tube 233.

Next, as shown in FIG. 14A, the jacketing tube 231, that is, jacketing tube 231 being attached to the supporting tube 233 whose open end was closed with a plug 235 was immersed, for three hours, in a 10 wt % aqueous solution of hydrofluoric acid 241 filling a tank 243. Then, the jacketing tube 231 was transferred into another tank 247 filled with purified water 245 as shown in FIG. 14B for washing roughly. Finally, a shower 249 of purified water was poured onto the jacketing tube 231 in question for rinsing as shown in FIG. 14C, and compressed air was applied to blow off water droplets, and the jacketing tube 231 was left to dry.

To an end of a core-rod 251 which had been processed to have a specified dimension was attached a supporting rod 253 made of natural silica glass having an outer diameter and length of about 25 mm and about 300 mm, respectively, as shown in FIG. 15. The supporting rod 253 attached to the core-rod 251 was fixed via a chuck 255 to a vertically movable lathe. The supporting tube 233 attached to a jacketing tube 231 was fixed to the same lathe via another chuck 257. The core-rod 251 was allowed to slowly descend in a direction as indicated by the arrow in FIG. 15, until it was inserted into the jacketing tube 231.

Then, as shown in FIG. 16, the jacketing tube 231 housing the core-rod 251 in its cavity was removed from the lathe, and a cap 259, which is made of silicon rubber and has an outwardly tapered profile, was applied to the end of the jacketing tube 233 from where the core-rod was inserted. Then, in the same manner as described above, the capped glass assembly was placed in a 10 wt % aqueous solution of hydrofluoric acid for three hours. The glass assembly was then transferred into another tank filled with purified water for washing roughly. Finally, a shower of purified water was poured onto the glass assembly for rinsing, and compressed air was applied to blow off water droplets, and the glass assembly was left to dry.

Next, a vacuum unit was connected to the open end of the supporting tube 233 of the glass assembly including the core-rod 251 so that air could be aspirated from the gap between the core-rod 251 and the jacketing tube 231 to reduce the pressure thereof, and the glass assembly was set to a fiber-drawing equipment. As the glass assembly was allowed to slowly descend into a furnace, its drawn end was melted by heating to be welded and elongated. Then, fiber-drawing was initiated. The rest occurred as in the usual fiber-drawing: the preform was advanced towards the furnace as the resulting fiber was taken up, and thus collapsing and fiber-drawing proceeded simultaneously.

The resulting thread for an optical fiber was taken up by a take-up capstan so as to have a diameter of the glass portion of 125 μm, and the glass fiber was coated with a UV curable resin and cured by irradiated UV ray to give a coated fiber having a diameter of 250 μm. As a result of carrying out fiber-drawing according to the present invention, the occurrence of failures such as breakage of fibers, defective diameter fluctuation, etc. was minimized and satisfactory fiber-drawing was achieved.

The purified water used in the cleaning step preferably includes purified water prepared by ion exchanging method whose electric conductivity is kept 1 μA or lower. In a separate test, purified water whose electric conductivity was over 1 μA was used in the cleaning step. In this test, the occurrence of defective diameter fluctuation increased up to 0.05 time/km which is 10 to 50 times as large as that observed in a conventional method (0.001 to 0.005 time/km). Thus, it was found, it is important to control the purity of water such that its electric conductivity be kept 10 μA or lower.

### Example 6

A core soot was prepared by VAD method as in Example 5. The core soot was sintered and elongated into a core-rod having an outer diameter of 30 mm.

Separately, a silica glass tube having an outer and inner diameters of 90 and 33 mm, respectively, was prepared to serve as a jacketing tube as in Example 5. FIG. 12 shows an exemplary arrangement of a core-rod and a jacketing tube.

The numerals enclosed by divergent arrows in FIG. 12 represent the relative sizes of the involved components, that is, when the outer diameter of the central portion is made 1, the outer diameter of the core-rod corresponds to 4.5. On the other hand, the outer diameter of the jacketing tube corresponds to 13, when the outer diameter of the central portion is 1.

FIG. 15 illustrates the insertion of a core-rod into a jacketing tube as in Example 5. The inner surface of the jacketing tube was free from the adherence of foreign matters and its lengthwise profile was uniformly flat. The jacketing tube was set to a glass-working lathe, and one of the tips was heated by oxygen/hydrogen flame to be sealed. A supporting tube was welded to an inert end of the jacketing tube. After being cooled, the jacketing tube was removed from the lathe.

When the ends of the jacketing tube and supporting tube were heated by using oxygen/hydrogen flame to be melted, and the two melted ends are brought into contact with each other to be welded, the joint was shaped using a trowel such that the inner diameter of the joint was practically the same with that of the jacketing tube.

A core-rod, which had been manufactured by VAD method and processed to have a specified dimension, was set to a lathe, a silica glass supporting rod was welded to an inert end of the core-rod using oxygen/hydrogen flame, and the processed core-rod was removed from the lathe as in Example 5.

The core-rod and the jacketing tube were set to a vertically movable lathe, and the core-rod was inserted into the jacketing tube. The core-rod and jacketing tube were fixed to the lathe by joining the supporting rod and supporting tube attached thereto to respective chucks of the lathe. The core-rod was allowed to slowly descend in a direction indicated by the arrow in FIG. 15 until it was inserted into the jacketing tube.

Then, as shown in FIG. 16, the jacketing tube 231 housing the core-rod 251 in its cavity was removed from the lathe, and a cap 259 was applied to the end of the jacketing tube 233 from where the core-rod was inserted. Then, in the same manner as described above, the capped glass assembly was immersed in an aqueous solution of hydrofluoric acid. The glass assembly was then transferred into a tank filled with purified water. Finally, a shower of purified water was poured onto the glass assembly for rinsing, and compressed air was applied to blow off water droplets, and the glass assembly was left to dry.

FIG. 17 is a schematic view for showing how a core-rod 335 is inserted into and housed in a jacketing tube 331. In this particular example, the core-rod had an outer diameter of 30 mm while the jacketing tube had an inner diameter of 33 mm: the difference between the outer diameter 341 of the core-rod and the inner diameter 343 of the jacketing tube was 3.0 mm which is significantly larger than 1.0 mm or the lowest limit according to the present invention.

Next, a vacuum unit was connected to the open end of the supporting tube of the glass assembly so that air could be aspirated from the cavity within the jacketing tube to reduce the pressure there, and the glass assembly was set to a fiber-drawing equipment. As the glass assembly was allowed to slowly descend into a furnace, its drawn end was melted by heating to be welded and elongated. Then, fiber-drawing was introduced. The rest occurred as in the usual fiber-drawing: the preform was advanced towards the furnace as the resulting fiber was taken up, and thus collapsing and fiber-drawing proceeded simultaneously. The resulting thread was taken up by a take-up capstan and further extended into a glass fiber with a diameter of 125 μm, and the glass fiber was coated with a UV curable resin to give an optical fiber having a diameter of 250 μm.

### Example 7

A core-rod and jacketing tube were separately prepared as in Example 5.

FIG. 19 is a diagram for showing how a core-rod is inserted into a jacketing tube according to the present invention. The inner surface of a jacketing tube 431 was free from the adherence of foreign matters and its lengthwise profile was uniformly flat. The jacketing tube was set to a glass-working lathe. To an inert end of the jacketing tube was welded a supporting tube 432 whose outer and inner diameters were 90 and 70 mm, respectively. After being cooled, the glass assembly was removed from the lathe.

When the ends of the jacketing tube and supporting tube were heated by using oxygen/hydrogen flame to be melted, and the two melted ends are brought into contact with each other to be welded, the joint was shaped using a trowel such that the outer diameter of the joint was practically the same with that of the jacketing tube.

A core-rod 35, which had been manufactured by VAD method and processed to have a specified dimension, was set to a lathe, a silica glass supporting rod 36 was welded to an inert end of the core-rod using oxygen/hydrogen flame, and the processed core-rod was removed from the lathe. The supporting rod 36 was made of natural silica glass and had an outer diameter and length of about 25 mm and about 300 mm, respectively.

The core-rod 435 and the jacketing tube 431 were set to a vertically movable lathe, and the core-rod 435 was inserted into the jacketing tube 431. The core-rod and jacketing tube were fixed to the lathe by joining the supporting rod 436 and supporting tube 432 attached thereto to respective chucks 437 and 433 of the lathe. The core-rod 435 was allowed to slowly descend in a direction indicated by the arrow in FIG. 19 until it was inserted into the central cavity of the jacketing tube 431.

FIG. 20 shows how a core-rod is inserted into and housed in a jacketing tube.

Next, a vacuum unit was connected to the open end of the supporting tube of the glass assembly so that air could be aspirated from the cavity within the jacketing tube to reduce the pressure there, and the glass assembly was set to a fiber-drawing equipment. As the glass assembly was allowed to slowly descend into a furnace, its drawn end was melted by heating to be welded and elongated. Then, fiber-pulling was introduced.

The rest occurred as in the usual fiber-drawing: the preform was advanced towards the furnace as the resulting fiber was taken up, and thus collapseing and fiber-pulling proceeded simultaneously. The resulting thread was taken up by a take-up capstan and further extended into a glass fiber with a diameter of 125 μm, and the glass fiber was coated with a UV curable resin to give an optical fiber having a diameter of 250 μm.

### Example 8

A core-rod and a jacketing tube were separately prepared as in Example 5.

The jacketing tube was set to a glass-working lathe, and, while one of the tips was exposed to oxygen/hydrogen flame, both of its ends were slowly pulled. Then, the end was melted/softened, and stretched to give a tapered profile. Finally, when the end was cut by flame-heating, it was sealed. Next, one end of the core-rod was heated by flame to be melted and the melted end was pulled to be tapered.

FIG. 21 is a diagram for showing how the core-rod was inserted into and housed in the jacketing tube. In the example shown in FIG. 21, the taper of the jacketing tube had a length of 120 mm. The taper of the core-rod had a length of 40 mm. To the opposite (inert) end of the jacketing tube was attached a supporting tube (not shown). The glass assembly was set to a fiber-drawing equipment. One end of the glass assembly was slowly advanced into a furnace, and when the end reached a high temperature zone, the end was melted and glass elements were welded to be collapsed. Then, the welded portion was elongated and fiber-pulling was introduced.

The pressure within the jacketing tube was reduced by means of a vacuum unit connected to the supporting tube attached to the jacketing tube, which promoted the collapsing of the glass elements. The glass assembly was advanced towards the furnace as the resulting fiber was taken up, and thus collapsing and fiber-drawing proceeded simultaneously. The resulting thread was taken up by a take-up capstan and further extended into a glass fiber with an outer diameter of 125 μm, and the glass fiber was coated with a UV curable resin to give an optical fiber having a diameter of 250 μm.

### Example 9

Being processed as in Example 8, a core-rod was allowed to have an end with a blunt-angled taper as shown in FIG. 22. The core-rod was inserted into a jacketing tube, and the glass assembly was subjected to fiber-pulling as in Example 8. The collapsing of the jacketing tube to the core-rod and the onset of stable fiber-drawing occurred earlier than in Example 8. Adjustment for obtaining a fiber having a diameter of 125 μm completed comparatively quickly. Moreover, the core/cladding ratio of the fiber is closer to a specified value. The time required for stable fiber-drawing was significantly reduced.

### Example 10

A core-rod and a jacketing tube were separately prepared as in Example 5.

FIG. 24 gives a diagram for showing how the core-rod was inserted into the jacketing tube. The inner surface of the jacketing tube was free from the adherence of foreign matters and its lengthwise profile was uniformly flat. The jacketing tube was set to a glass-working lathe. To an inert end of the jacketing tube was welded a supporting tube whose outer and inner diameters were 90 and 70 mm, respectively. After being cooled, the glass assembly was removed from the lathe.

The core-rod which had been processed to have a specified dimension was set to a lathe, and one of its ends was heated by means of oxygen/hydrogen flame to be tapered. A silica glass supporting base with a diameter and length of 30 and 300 mm, respectively, and a silica glass supporting rod with a diameter and length of 25 and 300 mm were separately prepared. The two were joined together. Then, the supporting base was cut to have a thickness of about 20 mm. The supporting base was directly welded to an inert end of the core-rod. After being cooled, the core-rod was removed from the lathe.

Next, the core-rod and jacketing tube were mounted to a vertically movable lathe, to carry out insertion operation. The jacketing tube was fixed to the lathe by holding the supporting tube with a chuck attached to the lathe, while the core-rod was fixed to the same lathe by holding the supporting rod with another chuck attached to the lathe. The core-rod was allowed to slowly descend until it was inserted in the jacketing tube (see FIG. 24). Then, it was confirmed that the lowest end of the core-rod was positioned at the center of the jacketing tube, and it came rightly in contact with the inner surface of the jacketing tube (see FIG. 25).

Then, the chuck used for the insertion of the core-rod 635 into the jacketing tube 631 was removed as shown in FIG. 26. An annular spacer 651 having an outer diameter of 69.5 mm and thickness of about 10 mm containing a central opening of a diameter of 25.5 mm was transferred, from the open end of a supporting tube 633, around the supporting rod 638, and displaced inward until it engaged with the inner surface of the jacketing tube 633. Namely, with regard to the drawn end of the glass assembly, alignment of the core-rod with the jacketing tube 636 (635 in the figure) was achieved by butting the tip of the former against the summit of the central cavity of the latter, while with regard to the inert end of the glass assembly, alignment of the core-rod with the jacketing tube 636 was achieved by means of the spacer. This arrangement made it possible to align the core-rod with the jacketing tube as much as possible over its full length. FIG. 27 shows schematic sectional views of two representative disc spacers used in the examples.

A vacuum unit was connected to the open end of the supporting tube of the glass assembly prepared as above so that air could be aspirated from the cavity within the jacketing tube to reduce the pressure there, and the glass assembly was set to a fiber-drawing equipment. As the glass assembly was allowed to slowly descend into a furnace, its drawn end was melted by heating to be welded and elongated. Then, fiber-pulling was introduced. The rest occurred as in the usual fiber-drawing: the preform was advanced towards the furnace as the resulting fiber was taken up, and thus collapsing and fiber-drawing proceeded simultaneously.

The resulting thread was taken up by a take-up capstan and further extended into a glass fiber with an outer diameter of 125 μm, and the glass fiber was coated with a UV curable resin to give an optical fiber having a diameter of about 250 μm. The fiber was cut at 2 km intervals, and the core eccentricity was checked at the both cut ends of them. The alignment was found satisfactory, that is, for all the checks, the difference between the center of the cladding and that of the core was 0.2 μm or less. Diameter fluctuation during fiber-drawing was not observed and entrapment of air bubbles was not observed either.

A jacketing tube made of synthetic silica glass in which the OH-group concentration is 1000 ppm or lower, preferably 1 ppm or lower was combined with a common core-rod, and a fiber was prepared by a method of the present invention, for example, method as described in Example 10. A light beam having a wavelength of 1385 nm was passed through the fiber and the transmission loss (loss due to OH absorption) of the fiber was measured. The loss was found to be 0.4 dB/km or less. More specifically, the loss was in the range of 0.29 to 0.38 dB/km. Thus, this fiber had a signal transmission characteristic suitable for the transmission of signals based on a WDM system which commands a broad band.

According to the method of the present invention for preparing a preform of an optical fiber which allows the tip of a preform to be processed to have a desired shape, it is possible to subject a prepared preform directly to fiber-drawing, and thus to inhibit the occurrence of failures which might result from the shaping of the tip of preform. Moreover, use of a preform of an optical fiber prepared according to a method of the present invention enables the duration of initial unstable fiber-drawing phase lasting from the onset of fiber-drawing till the establishment of stable fiber-drawing to be reduced, and thus efficient manufacture of optical fibers.

Moreover, according to the present invention, it is possible to clean the surface of a preform without exposing the interior of a jacketing tube to external polluting sources. Therefore, according to the present invention, it is possible to reduce the occurrence of failures such as fractures or diameter fluctuation which might be otherwise encountered when a preform is thinned via fiber-drawing into an optical fiber.

Furthermore, an end of a jacketing tube is melted and thinned by pulling such that the tip is tapered and sealed. Similarly an end of a core-rod is melted and thinned such that the end is tapered. The core-rod is inserted into the jacketing tube, and a spacer is provided to the end of the jacketing tube from where the core-rod was inserted therein such that the core-rod is concentrically arranged with respect to the jacketing tube. As a result, according to one example of the present invention, the divergence of the central axis of a core-rod from that of a jacketing tube was 0.2 μm or less for all the fibers tried. The diameter fluctuation and entrapment of air bubbles during fiber-drawing were not observed either.

1. A method for manufacturing an optical fiber, comprising the steps of:
forming a glass body containing a core;
preparing a glass tube which forms a cladding portion;
processing one end of the glass tube to be drawn so as to be tapered to make an over-jacketing glass tube;
inserting the glass body into the over-jacketing glass tube; and
collapsing the over-jacketing glass tube with the glass body by heating to make a glass assembly.

2. The method according to claim 1, wherein
a tapered end of the over-jacketing glass tube is similar in form to a meniscus during drawing from the glass assembly to make the optical fiber.

3. The method according to claim 1, wherein the step of collapsing the over-jacketing glass tube with the glass body by heating comprises the steps of:
sealing one end of the glass assembly by heating, and collapsing the over-jacketing glass tube with the glass body by heating at the same time of drawing to the optical fiber while reducing a pressure within a gap between the glass body and the glass tube.

4. The method according to claim 1, wherein the step of processing one end of the glass tube to be tapered to make the over-jacketing glass tube comprising abrasion-machining one end of the glass tube, and cleaning the abraded portion.

5. The method according to claim 4, further comprising, polishing of the abraded portion.

6. The method according to claim 1, further comprising
processing one end of the glass body so as to be tapered to make a processed glass body, and the tapered portions of both the over-jacketing glass tube and the processed glass body are formed in nearly the same longitudinal position at the commencement of collapsing the over-jacketing glass tube with the glass body by heating.

7. The method according to claim 1, wherein the step of processing one end of the glass tube to be drawn so as to be tapered to make the over-jacketing glass tube comprises the steps of:
heating and elongating one end of the glass tube to be drawn so as to be tapered to make the over-jacketing glass tube; and
sealing the tapered end of the over-jacketing glass tube.

8. The method according to claim 1, further comprising
processing one end of the glass body so as to be tapered to make the processed glass body,
inserting the processed glass body into the over-jacketing glass tube; and
making the ends of both the processed glass body and the over-jacketing glass tube together in nearly the same longitudinal position.

9. A method for manufacturing an optical fiber, comprising the steps of:
forming a glass body containing a core;
preparing a glass tube which will form a cladding portion;
cleaning the outer surface of the glass tube;
inserting the glass body into the glass tube; and
collapsing the glass tube with the glass body by heating.

10. (canceled)

11. The method according to claim 9, further comprising the following steps of; sealing one end of the glass tube to be drawn; and
attaching a supporting tube to the opposite end of the glass tube to be drawn, and wherein the step of cleaning the outer surface of the glass tube is made after inserting the glass body into the glass tube and attaching a plug to the supporting tube.

12. A method for manufacturing an optical fiber comprising the following steps of:
forming a glass body containing a core;
preparing a glass tube which will form a cladding portion;
first cleaning the outer surface of the glass tube;
wrapping the outer surface of the glass tube with a film;
inserting the glass body wrapped with the film into the glass tube;
removing the film from the glass body after inserted into the glass tube;
attaching a plug to an open end of the glass tube with the glass body;
second cleaning the outer surface of the glass tube with the glass tube; and
collapsing the glass tube with the glass body by heating.

13. The method according to claims 9 to 12, wherein all the steps of cleaning the outer surface of the glass tube are comprising of treating the outer surface of the glass tube by using an aqueous solution of hydrofluoric acid by 1 to 20 wt %, rinsing it with pure water, and drying it.

14. The method according to claim 13, comprising of rinsing the outer surface of the glass tube with pure water having electric conductivity of 1 μA or less.

15. (canceled)

16. (canceled)

17. (canceled)

18. (canceled)

19. (canceled)

20. (canceled)

21. (canceled)

22. A method for manufacturing an optical fiber comprising the steps of:
forming a glass body containing a core;
preparing a glass tube which will form a cladding portion;
sealing one end of the glass tube to be drawn by processing at least internal surface of the end of the glass tube so as to be tapered to make an over-jacketing tube;
inserting the glass body into the over-jacketing glass tube, providing a spacer so as to keep a gap in substantially constant longitudinally between the outer surface of the glass body and the inner surface of the over-jacketing glass tube except the tapered portion, and
collapsing the over-jacketing glass tube with the glass body by heating.

23. The method according to claim 22, further comprising of attaching a supporting tube to an opposite end of the glass tube to be drawn, and attaching a supporting rod to an opposite end of the glass body to be drawn, wherein the spacer is provided into the gap between the outer surface of the supporting rod and the inner surface of the supporting tube.

24. The method according to claim 22, wherein one end of the glass rod is butted and aligned with one end of the glass tube to be tapered, so as to be arranged concentrically.

25. The method according to claim 22, wherein the spacer is provided after the step of inserting the glass body into the over-jacketing glass tube.

26. The method according to claim 22, further comprising the steps of:
attaching a supporting rod concentrically to an opposite end of the glass body to be drawn; and
attaching a supporting tube concentrically to an opposite end of the over-jacketing glass tube to be drawn.

27. The method according to claim 26, wherein the supporting rod comprises a stopper portion for keeping the spacer in position.

28. The method according to claim 22, wherein the spacer is made of silica glass.

29. The method according to claim 22, wherein the spacer has a circular cross-section with a first hole at the center and a second hole, wherein outer diameter of the spacer is selected to fit to the inner diameter of the over-jacketing glass tube, outer diameter of the first hole is selected for the glass rod to pass through therein, and outer diameter of the second hole is selected to be sufficient to reduce a pressure within a gap between the over-jacketing glass tube and the glass rod during fiber-drawing.

30. The method according to claim 22, wherein the spacer has a circular cross-section with a first hole at the center and a plural of second slitted holes radially arranged, wherein outer diameter of the spacer is selected to fit to the inner diameter of the over-jacketing glass tube, outer diameter of the first hole is selected for the glass rod to pass through therein, and outer diameter of a plural of second holes radially arranged are selected to be sufficient to reduce a pressure within a gap between the over-jacketing glass tube and the glass rod during fiber-drawing.

31. The method according to claim 22, wherein the spacer has a circular cross-section with a first hole at the center and a lot of second small holes, wherein outer diameter of the spacer is selected to fit to the inner diameter of the over-jacketing glass tube, outer diameter of the first hole is selected for the glass rod to pass through therein, and outer diameter of a lot of second small holes are selected to be sufficient to reduce a pressure within a gap between the over-jacketing glass tube and the glass rod during.

32. The method according to claim 22, further comprising a step of processing one end of the glass body to be drawn so as to be, wherein the tapered angle of the glass body is sharper than that of the over-jacketing glass tube.

33. A method for manufacturing an optical fiber comprising the steps of:
forming a glass body containing a core;
preparing a glass tube which will form a cladding portion;
processing at least a one end of the glass tube to be drawn to make an over-jacketing glass tube;
inserting the glass body into the over-jacketing glass tube; and
collapsing the over-jacketing glass tube with the glass body by heating; wherein the resulting optical fiber has a transmission loss of 0.4 dB/km or less at a wavelength of 1385 nm.

34. The method according to claim 33, wherein the glass tube is made of synthetic silica glass of 100 ppm or less in OH-group concentration.
